(19) United States
(12) Patent Application Publication
(10) Pub. No.: US 2006/0064508 A1
(43) Pub. Date: Mar. 23, 2006

(54) Method and system to store and retrieve message packet data in a communications network

(76) Inventors: Ramesh Panwar, Pleasanton, CA (US); Umesh Kasture, Pune (IN)

Correspondence Address: Patrick Reilly, Box 7218, Santa Cruz, CA, 95061-7218, US

(21) Appl. No.: 10/944,271

(22) Filed: Sep. 17, 2004

(51) Int. Cl. G06F 15/16

(52) U.S. Cl. 709/250

(57) ABSTRACT

A system and method allocate memory by a network processor system in an off-chip DRAM. Upon initiation, an on-chip DRAM controller module creates a software structure that allocates blocks of memory locations in the DRAM as packet memory blocks. As a CPU, input/output module, and intrusion detection circuit read and write packets from the DRAM across a common bus, the DRAM controller module facilitates the rapid flow of packets in and out of the DRAM. FreeLists of packet buffer blocks are maintained by both the DRAM controller and the CPU for quick access in directing the flow of packets to available packet buffer blocks.

### FIELD OF THE INVENTION

This invention relates in general to memory storage devices and techniques supportive of electronic message communication and, more particularly, to enabling access of message packet data to a processor.

### BACKGROUND OF THE INVENTION

Network traffic processing systems are used to route electronic message traffic in communications networks. Communications networks that require electronic message routing include the Internet, intra-nets, extra-nets, computer networks, and telephony networks. The efficiency that network traffic processing systems process messages and message components, e.g. packets, often has a significant effect on the over-all efficiency of a communications network.

In addition, the increasing danger of intrusions into communications networks, and to protected sections of the communications network, by software viruses, to include software worms, are escalating both the potential traffic load that a network may bear as well as the complexity of the behavior of network traffic processing systems employed to protect against intrusions of viruses.

There is, therefore, a long felt need to provide systems and methods that increase the efficiency that network traffic processing systems process message traffic.

### SUMMARY OF THE INVENTION

It is an object of the present invention to provide a system and method to process an electronic message, and a component of an electronic message, is provided. This object and other objects of the method of the present invention will be made apparent in light the present disclosure. According to principles of the method of the of the present invention in a preferred embodiment, a system and method to dynamically allocate memory in a random access memory for reading to, and writing from a network traffic processing system, (“network processor system”) are provided. In certain preferred embodiments of the present invention, the network processor system includes a network controller processor, and optionally a system memory, communicatively coupled with a random access memory, e.g. a packet memory. The network processor system forms a software model of the memory locations of the packet memory, where the software model assigns a plurality of packet addresses to a plurality of separate block of memory addresses of the packet memory. The network processor system receives a first packet and then stores the first packet in a block of memory addresses of the packet memory that are associated with a first packet address of the software model.

Certain alternate preferred embodiments of the method of the present invention include the step of forming a packet group buffer in the software model, where the packet group buffer stores the packet addresses individual packets stored in the packet memory. The packet memory may be or include a suitable random access memory, dynamic random address memory, or other memory device known in the art. Certain still alternate preferred embodiments of the method of the present invention may further or alternatively include (1.) determining the length of each packet associated with each packet address stored in the packet group buffer, and (2.) storing the length in a packet group buffer in a memory, where each length stored in association with the corresponding packet address. The software model may present a plurality of packet group buffers, and a packet group buffer queue, where the packet buffer group queue contains designations of a plurality of packet group buffers. Each designated packet group buffer is selected for locating at least one packet from the packet addresses listed in the corresponding packet group buffer, for use in reading the packet from the packet memory. The network processor system may further include an on-chip memory, and the packet group buffer may be stored in the on-chip memory of the network processor system.

Certain yet alternate preferred embodiments of the present invention provide a network traffic processing system having a memory manager device, such as a DRAM controller module (“DCM”), where the memory manager device is communicatively coupled with a network controller processor of the system, and a random access memory. The memory manager device stores a software model of the random access memory and a device driver. The software model allocates memory blocks of the random access memory as uniquely addressed packet addresses. The device driver determines the unused memory blocks as designated by the packet addresses and then informs the network control processor of the packet addresses of the unused memory blocks. The system may also include a packet group buffer as defined in the software model, where the packet group buffer stores the packet addresses of individual packets stored in the random access memory. The packet group buffer may alternatively or additionally be stored in the random access memory of the network processing traffic system. The packet group buffer may further include a stored length of each packet associated with each packet address as stored in the packet group buffer, where the length of each packet is stored in the packet group buffer in association with the corresponding packet address.

Certain additional alternate preferred embodiments of the present invention provide a method to manage (1.) packet memory storage and (2.) access in and from a packet memory. Accordingly, a network processor system having a CPU and a system memory is provided, where the CPU requests a packet memory block designation from a FreeList stored in the system memory. The FreeList has internally stored a plurality of packet memory block designations of packet memory blocks of the packet memory, where each listed packet memory block is available, i.e. “free”, to accept storage of a memory packet. The CPU receives a selected packet memory block designation from the FreeList and then writes the packet from the network processor to the packet memory block of the packet memory corresponding to the selected packet memory block designation.

An updated copy, or data mirror of the PBG FreeList 21 may be stored in the, the DRAM and/or the system memory in additional FreeList buffer(s), whereby the memory manager device, the packet memory and the system memory maintain substantively identical FreeLists substantively contemporaneously. Alternatively or additionally, an update copy, or second data mirror, of the packet buffer group data structure may be recorded in a second packet buffer group memory of the memory manager device, the packet memory and/or the system memory, whereby the packet buffer group data structure and the second packet buffer group memory are maintained substantively identical and contemporaneously.

Certain still other alternate preferred embodiments of the method provide a packet group buffer queue data structure in the memory manager device, system memory and/or the packet memory. The packet group buffer queue data structure contains addresses of packet memory block designations, and stores at least one packet memory block designation of a packet scheduled for, or intended for, egress from the packet memory.

Other objects, advantages, and capabilities of the present invention will become more apparent as the description proceeds.

In summary, what has been described above are the preferred embodiments for a system and method for processing data packets in a network traffic message processing system. While the present invention has been described by reference to specific embodiments, it will be obvious that other alternative embodiments and methods of implementation or modification may be employed without departing from the true spirit and scope of the invention.

### BRIEF DESCRIPTION OF THE DRAWINGS

These, and further features of the invention, may be better understood with reference to the accompanying specification and drawings depicting the preferred embodiment, in which:

FIG. 1 is a schematic diagram of a network processor communicatively coupled with a dynamic random access memory device (“DRAM”);

FIG. 2 is a packet group buffer structure as stored in the DRAM and/or DRAM controller module of the network processor of FIG. 1;

FIG. 3 is a schematic illustration of a packet group buffer queue structure as stored in the DRAM and/or DRAM controller module of the network processor of FIG. 1;

FIG. 4 is a schematic illustration of a packet group buffer queue cache of the DRAM controller module and/or of DRAM of FIG. 1;

FIG. 5 is a schematic diagram of the network processor and DRAM of FIG. 1, wherein packet group buffer enqueue transaction components are indicated; and

FIG. 6 is a schematic diagram of the DRAM, the DRAM controller module, the input/output module and a CPM memory of the network processor FIG. 1, wherein packet group buffer dequeue transaction components are indicated.

FIG. 7 is a schematic of a second preferred embodiment of the present invention, or second version, as located within a network computer.

FIG. 8 is a top level block diagram of the second version of FIG. 7.

FIG. 9 is a block diagram of a Packet group buffer queue block (“PGBQB”) of the second version of FIG. 7.

FIG. 10 is a block diagram of a packet group buffer queue (“PGBQ”) state machine of the second version of FIG. 7.

FIG. 11 is a top level block diagram of a packet direct memory access block (“DMA”) of the second version of FIG. 7.

FIG. 12 is a top level block diagram of a packet DMA configured for off chip relating within the second version of FIG. 7.

FIG. 13 is a block diagram of an A parser of the second version of FIG. 7.

FIG. 14 is a block diagram of an E composer of the second version of FIG. 7.

FIG. 15 is a top level block diagram of a packet DMA configured for from chip relating within the second version of FIG. 7.

FIG. 16 is a block diagram of an E parser of the second version of FIG. 7.

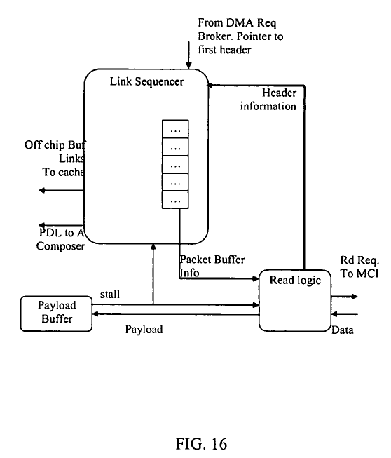

FIG. 17 is a block diagram of an A composer of the second version of FIG. 7.

FIG. 18 is a schematic diagram of a FreeList implementation of the second version of FIG. 7.

FIG. 19 is block diagram of an MCIB interface configurable within the second version of FIG. 7.

FIG. 20 is block diagram of an MCIB configurable within the second version of FIG. 7.

FIG. 21 is block diagram of a TEB configurable within the second version of FIG. 7.

FIG. 22 is schematic diagram of smart memory operations block configurable within the second version of FIG. 7.

FIG. 23 is a schematic diagram of a parallel adder using an 8-bit adder configurable within the second version of FIG. 7.

FIG. 24 is a schematic diagram of a parallel adder using a 16-bit adder configurable within the second version of FIG. 7.

### DETAILED DESCRIPTION OF THE INVENTION

The following description is provided to enable any person skilled in the art to make and use the invention and sets forth the best modes contemplated by the inventor of carrying out his or her invention. Various modifications, however, will remain readily apparent to those skilled in the art, since the generic principles of the present invention have been defined herein.

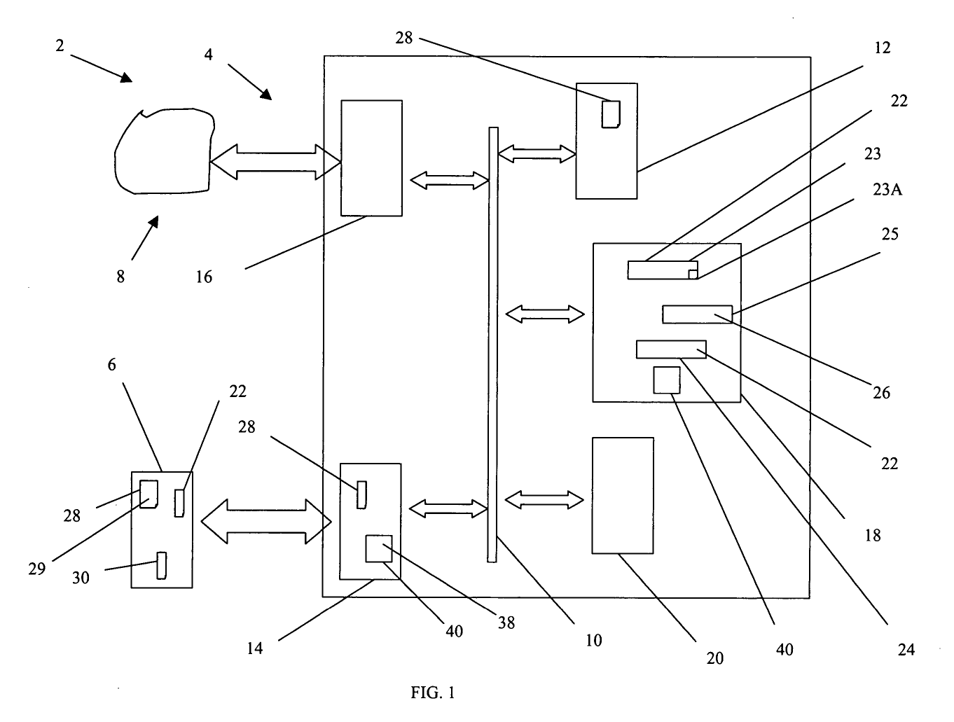

Referring now generally to the drawings, and particularly to FIG. 1, a first preferred embodiment of the present invention 2, or first version 2, includes a network processor 4 and a DRAM 6. The first version 2 is communicatively coupled with a communications network 8, where the communications network 8 may be, comprise, or be comprised within the Internet, an intranet, an extranet, a telephony network, or other suitable communications network known in the art. The network processor 4 has an on-chip communications bus 10 that communicatively couples several on-chip components of the network processor 4, to include a central processor unit (“CPU”) 12, a DRAM controller module (“DCM”) 14, an input output module 16, a system memory 18, and an intrusion detection unit 20. The input/output module 16, or IOM 16, communicatively couples the communications network 8 with the network processor 4 and the communications bus 10. The DCM 14 is a memory manager device and provides bi-directional communication between the DRAM 6, or DRAM channel 6, and the communications bus 10. The system memory 18 is employed by the CPU 12 in the processing packet data and other information. The intrusion detection unit 20 compares signatures of viruses with the contents of packet data as provided and directed by the CPU 12.

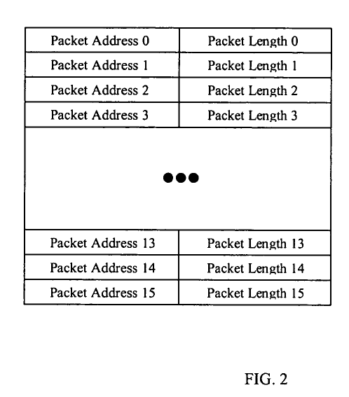

Referring now generally to the Figures, and particularly FIG. 2, the DRAM 6, or DRAM channel 6, allows 24 MB of memory for packet data. The 28 MB DRAM memory 6 is organized into three areas with the organization being under software control. It is recommended that the 28 MB memory 6 available in this channel be organized as follows:
Packet Group Buffer (“PBG”) area (1.5 MB)
Packet Group Buffer Queue (“PBG Q”) area (1.5 MB)
Packet area (24 MB)

While packets are stored using 128 byte buffers of the DRAM 6, the DRAM 6 also stores address and packet length information for packets in special buffers 22 that serve as the units for egress queue enqueue and dequeue operations. These buffers are referred to as a PGB's 22 (Packet Group Buffers). As shown in FIG. 2, each PGB 22 is a 128-byte buffer that contains 16 tuples. Each tuple in the PGB 22 consists of a 4-byte packet address 22A and 4-byte packet length 22B. Each PGB thus stores the address and length of 16 packets. The organization of the PGB 22 is shown in FIG. 2.

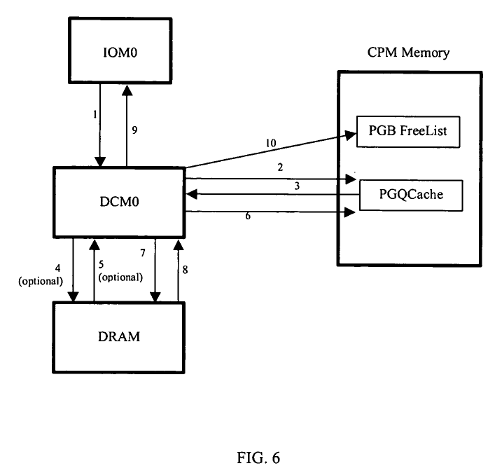

The packet length field 22B in the PGB 22 is used by the egress packet schedulers in an IOM0 16A (as per FIG. 6) and an IOM1 16B of the IOM 16 in an implementation of DRR scheduling. The 24 MB packet buffer memory requires, in the first version 2, 24*1024*1024/16*128=12K PGBs 22. A FreeList 23 of PGBs is maintained from which PGBs 22 are allocated as needed. The FreeList implementation of PGBs 22 has 12K bits in a FreeList BitVector array 23A thus requiring approximately 2 KB of area for the PGB FreeList23.

The PGB FreeList 23 is kept in the on-chip system memory 18, or CPM memory 18. PGBs 22 are consumed from the PGB FreeList 23 by the CPU 12 when a group of contiguous packets received from the fabric are enqueued for egress scheduling. PGBs are freed by the DCM 14 upon their request by the egress packet schedulers. DCM 14 contains a PGFL (PG FreeList) register that provides the memory address of the PG FreeList so that DCM 14 can update the free/use status of a PGB when the PGB is released upon egress packet scheduling.

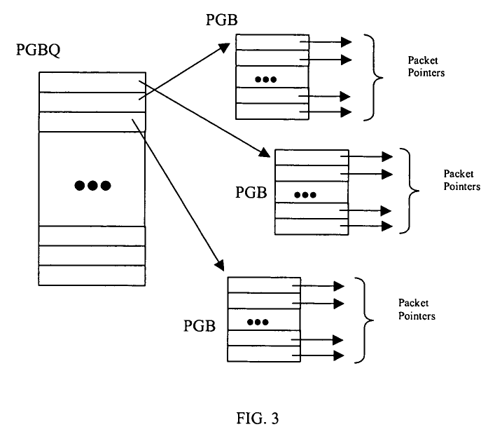

Referring now generally to the Figures, and particularly FIG. 3, a PGB area 24 in the DRAM 6 is followed by a PGBQ area 25 that contains queues of PGBs 22 called PGBQs 26 (PGB Queues). Each PGBQ 26 is actually a queue containing the addresses of PGBs 22 destined for egress scheduling. As the first version 2 may have a plurality of CPU's 12, the first version 12 may, in certain still alternate preferred embodiments of the method of the present invention, support 12 ports with 8 queue classes per port, up to 96 queues may be provided in the PGBQ area 25 (PGBQ0-PGBQ95). When the first version 2 is operating in Gigabit Ethernet mode (supporting 12 Gigabit Ethernet interfaces), the first version may be equipped with 96 PGBQs 26, where each queue can grow to contain 4K PGBs. The first version 2 includes, in preferred embodiments of the present invention as required, a space of 4096*4 bytes/PGB address*96 queues=1.5 MB for PGBQs 46. In 10 Gigabit Ethernet mode, the first version 2 may optionally have only 8 PGBQs 46, where each queue is allowed to grow to contain 12K PGBs. The use of PGBQ and PGBs is shown in FIG. 3.

Each PGBQ 26 is implemented as a queue-using read and write pointers of the DRAM memory 6. The read pointer points to the first non-empty location containing a PGB address 22A. This pointer is used to fetch the next PGB 22 upon a request by the egress packet schedulers in the IOM 16. The write pointer points to the first empty location where the address of a new PGB may be stored. All of the 96 PGBQs 46 are resident in contiguous memory in the DRAM 6 starting after the PGB area 24. The maximum number of entries in each PGBQ 26 is configured by a software model 28. The maximum number of entries in each PGBQ 26 is indicated by a corresponding PGQN (PGB Queue NumEntries) register. The DCM 14 contains registers PGQN0-PGQN95 to indicate the maximum number of entries in the 96 PGBQs 26 (only 8 registers are used 10 Gigabit Ethernet mode). The maximum number of entries in each PGBQ 26 is constrained to be a multiple of 16. Since each PGB pointer entry in the PGBQ 26 is 4 bytes, this implies, that the memory required for a PGBQ 26 is always a multiple of 64 bytes. The PGQN registers are 16 bit registers thus allowing each PGBQ 26 to contain a maximum of 64K PGBs.

The software model 28 may reside, be stored, or be distributively stored in the system memory 18, the DMC 14, the CPU 12, and/or elsewhere on the network processor 4. The software model 28 creates a data structure that associates selected memory blocks of the DRAM 6 with individual packet addresses. A PGQS (PGB Queue Size) 29 register is associated with each PGBQ 26 that indicates the current size of the corresponding PGBQ 26. The DCM 14 contains 96 registers PGQS0-PGQN95 which indicate the current size of the PGBQs 26 in terms of the number of packet buffers currently allocated to each of the PGBQs 26. The PGQS registers 29 are used by traffic management software of the first version 2 to enforce congestion based packet drops. These PGQS registers 29 are incremented when packets are enqueued by the CPU 12 upon their arrival from the fabric (not shown). The optional plurality of CPU's 12 may use parallel add operations to increment PGQS registers. The PGQS registers 29 are decremented upon the release of a packet buffer by DCM 14. The PGQS registers 29 are 32 bits wide: however, the upper 8 bits are reserved and always read zero.

The DCM 14 contains PGBS registers 29 PGQB0-PGQB95 that indicate the beginning address of the PGBQs 26 in DRAM memory 6 and registers PGQE0-PGQE95 that indicate the ending address of the PGBQs 26 in DRAM 6. These registers are 32 bits wide; however, the upper 8 bits are reserved and always read as zero.

The enqueuing and dequeuing of PGBs22 in each PGBQ 26 requires read and write pointers. Thus, DCM 14 contains registers PGQR0-PGQR95 that contain the read pointers for all the PGBQs 26. DCM 14 also contains registers PGBW0-PGBW97 that contain the right pointers for all the PGBQs 26. The read and write pointers are 32 bit registers; however, the upper 8 bits are reserved and always read zero. In addition to these registers, there are 32 bit registers PGQF0, PGQF1, and PGQF2 of the DCM 14 that indicate the empty/full status of the 96 PGBQs 26.

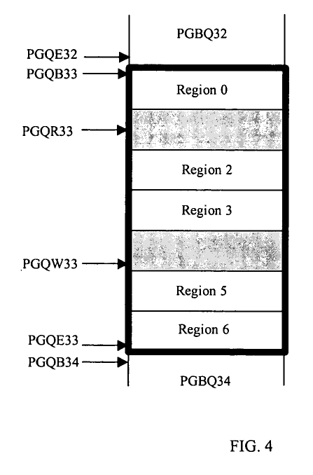

Referring now generally to the Figures, and particularly FIG. 3, where the number of entries in each PGBQ 26 is a multiple of 16, each PGBQ 26 may consist of regions 30 of 16 entries. At any given point in time, the PGBQ read pointer 32 is positioned within some 16-entry region, referred to as the ReadRegion 34. Similarly, at any given point in time, the right pointer is positioned within some 16-entry region, referred to as the WriteRegion. FIG. 4 shows the read and write regions in PGBQR33. This PGBQ has a total of 7 regions, numbered 0 through 6, and hence can accommodate up to 16*7=112 PGBs which imply that this queue can contain up to 112*16=1792 packet buffers. In FIG. 4 the ReadRegion 34 is a region numbered 1 while a WriteRegion 36 is a region numbered 4.

The ReadRegion 34 and WriteRegion 36 of each PGBQ 26 are cached on-chip in the system memory 18. This area of CPM memory 18 is referred to as the PGQCache 24. Since the ReadRegion 34 and WriteRegion 36 of PGBQ are 64 bytes each, the size of the PGB Cache is 96*64*2=12 KB. DCM 14 contains a 32-bit register, called the PGCA (PGBQCache Address) register that contains the base address of the PGBQCache 24.

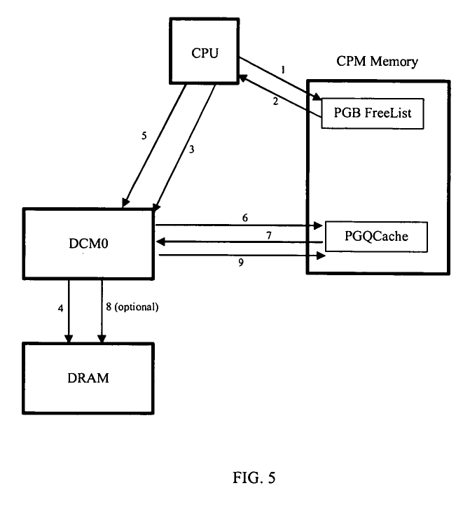

Referring now generally to the Figures, and particularly FIG. 5, the PGB Enqueue and Dequeue operations involve a number of steps. Note that the PGBs 22 (and not packets) are enqueued and dequeued in the egress queues the first version 2. The steps for PGB enqueue are shown in FIG. 5 and are as follows.
1. The CPU 12 sends a request to the PGB FreeList 23 to get a PGB 22.
2. The PGB FreeList 23 responds with the address of a free PGB 22.
3. The CPU 12 sends a request to the DCM 14 to write the PGB data into the DRAM 6.
4. DCM 14 writes the PGB data into the DRAM 6.
5. The CPU 12 requests DCM 14 to enqueue the PGB in the appropriate PGBQ 26.
6. DCM 14 requests the PGQCache 24 for the WriteRegion for the PGBQ 26.
7. PGQCache 24 returns the 64 byte WriteRegion of the PGBQ 26.
8. DCM 14 updates local copy of the 64 byte WriteRegion and increments the write pointer of the PGBQ. If the write pointer of the PGBQ 26 crosses into the next region, then the local copy of the WriteRegion 36 is flush to the DRAM 6.
9. DCM 14 sends an updated 64 byte WriteRegion to the PGQCache 24.

The steps for PGB Dequeue are shown in FIG. 6 and are as follows:
1. The egress scheduler IOM0 16A or IOM 1 of the IOM 16 sends a PGB dequeue request to DCM 14.
2. DCM 14 requests the PGQCache 24 for the ReadRegion of the PGBQ.
3. PGQCache 24 returns the 64 byte ReadRegion to DCM 14.
4. DCM 14 locates the PGB buffer for dequeue and updates the read pointer. If the read pointer crosses the region boundary, DCM 14 requests a new region from the PGBQ 26 in DRAM 6.
5. (Optional step) DRAM 6 responds with a new 64 byte ReadRegion for the PGBQ 26.
6. DCM 14 sends an updated ReadRegion to PGB Cache 24.
7. DCM 14 requests DRAM 6 to read the PGB 22.
8. DRAM 6 responds with the PGB read data.
9. DCM 14 forwards the PGB 22 to the egress scheduler that initiated the request.
10. DCM 14 requests the PGB FreeList 21 to return the dequeued PGB 22 to the FreeList.

Referring now generally to the Figures, and particularly FIG. 6, the packet buffer area in the DRAM 6 follows the PGBQ area. Each packet buffer is 128 bytes. There is a FreeList in on-chip system memory 18 that indicates the free/use status of each packet buffer. With 24 MB of packet buffering, we need 24*1024*1024/128=192K bits in a FreeList bit vector array. This implies that approximately 30 KB is sufficient for the packet buffer FreeList 23.

Packet buffers are consumed from the PBG FreeList 23 by the CPU 12 after processing of the packets that arrive from the fabric. DCM 14 contains a PBFL (packet buffer FreeList) register that provides the memory address of the packet buffer FreeList 23. The CPU 12s reserved packet buffers by invoking a FreeList Malloc operation on the FreeList 23. The DCM 14 can update the free/use status of a packet buffer by invoking the FreeList free operation when the packet buffer is released upon egress packet scheduling.

An updated copy 28, or data mirror 28 of the PBG FreeList 23 may be stored in the DRM 14, the DRAM 6 and/or the system memory 18 in additional FreeList buffer(s) 38, whereby the DRM 14, the packet memory 6 and the system memory 18 maintain substantively identical FreeLists 23 substantively contemporaneously. Alternatively or additionally, an update copy 38, or second data mirror 38, of the packet buffer group data structure may be recorded in a second packet buffer group memory 40 of the DCM 14, the packet memory 6nand/or the system memory 18, whereby the packet buffer group data structure and the second packet buffer group memory are maintained substantively identical and contemporaneously.

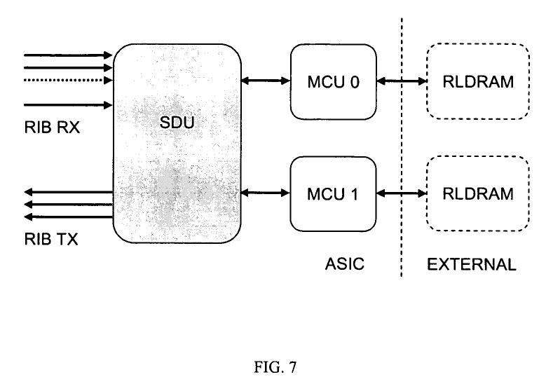

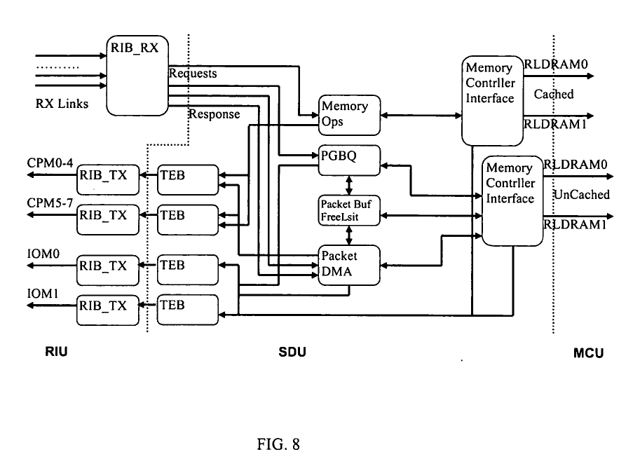

Referring now generally to the Figures and Particularly to FIG. 7 and FIG. 8, a second preferred embodiment of the present invention 42, or second version 42, includes a smart dram unit (“SDU”) 44. The second version 42 provides one or more of the following services:
Support for up to 128 MByte per instance of an RLDRAM 46 using two independent MCUs 48;
Configurable memory regions for:
Packet Buffers & PGBs 44;
PGBQ 46; and
Smart memory structures such as Hash Tables, Queues etc.; and
96 PGBQs 26 with configurable sizes (12 ports and 8 classes ).

The SDU 44 interfaces between CPMs 18, MCUs48 and the IOM0 16A for egress packet processing, off chip packet storage, off chip table/queue storage. The CPMs 18 store the packets in a Packet Buffer area 24 using Packet DMA services. The CPM 18 finds in-sequence packets and queues (enQueue's) the packets by means of PGBQs 26 for scheduling to IOM0 16A. The DCM 14 maintains the pointers in form of PGBs. The CPM 18 can also retrieve the packets back to the CPM memory 18 by using packet DMA commands. The IOM0 16A recovers (deQueue's) the PGB 22 at appropriate time, parses the PGB 22 to extract packet pointer and size. The packets are then read out by the IOM0 16A in chunks of packet buffer and sent over the egress port.

The SDU 44 provides one or more of the following services:
Packet store and restore services (Packet DMA)
PGBs 22 are written as needed by DCM 14 during Enqueue command and read out by IOM0 16A during Dequeue command.
FIFO view for the PGBQs 26, where PGBs 22 can be Enqueue and Dequeue
Smart Memory operations including hash tables, reads, writes etc.

The SDU 44 interfaces to the other modules and circuits in a semiconductor chip 46 via the ring interconnect 48. Transactions are received from a ring interconnect block (“RIB”) 50. RX queues from one or all the on-chip modules 12, 14, 16, 18 & 20 may be polled in round robin sequence. The requests are stored in request pool for each serving block and forwarded on availability. The RIB 50 interprets the OCC transaction and depending on the transaction, sends them over to the Memory Operation block (MOPB), PGBQ block (PGBQB) 52, Packet DMA block 54, or the Flow Manager Block 56. If the block is currently busy, the decoding stalls until the block is available. The responses are dispatched to the individual blocks directly.

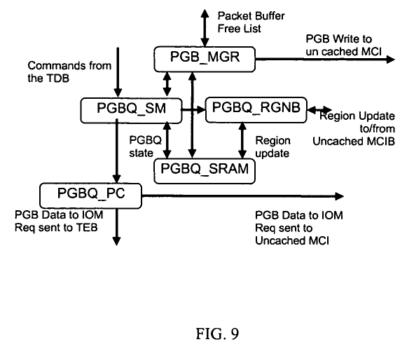

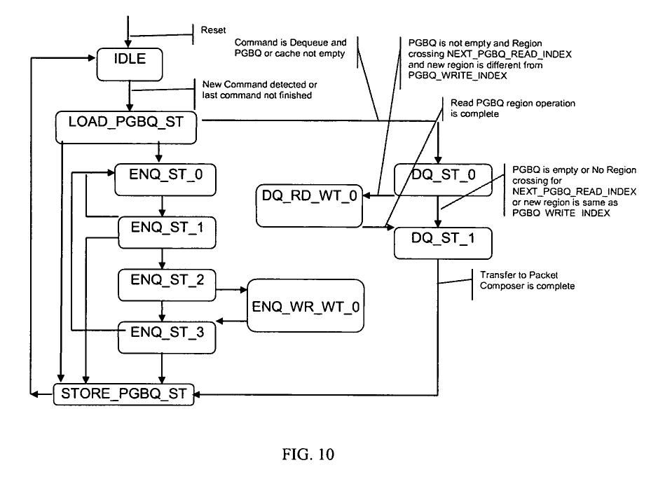

Referring now generally to the Figures and particularly to FIG. 9 and FIG. 10, a PGBQ block 58 supports Enqueue and Dequeue request for the PGB queues. The PGBQ block 58 may support 96 PGB queues and maintains status for some or all the queues. In addition the PGBQ block 58 provides accelerated access through caching of the head and tail of the queues.

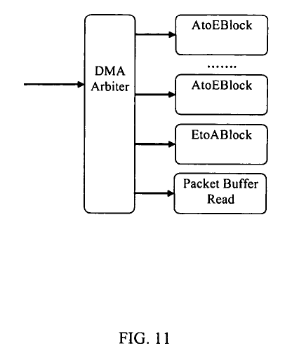

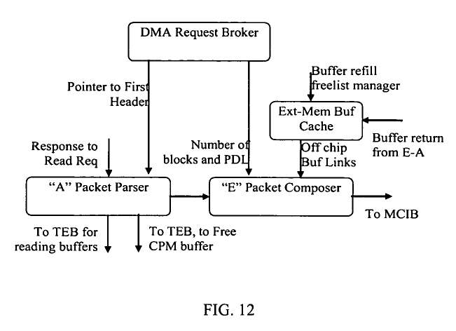

Referring now generally to the Figures and particularly to FIG. 11 and FIG. 12, the “A” packets can be stored in off chip memory 6 for queuing to egress or as temporary storage. A packet DMA block 60 converts the “A” formatted packet to “E1” or “E2” format and vice versa for off chip storage 6. The stored packet can be retrieved by the CPMs 12 in “A” format again. The IOM 16 can read out the packet buffers through PacketBufferRead command. A packet buffer FreeList block manages a FreeList for packet buffers. These buffers are used by the Packet DMA block 60 for storing the packets, and the PGBQ block 58 for storing the PGBs 22. The FreeList 23 may be maintained using off chip packet buffers (not shown).

Referring now generally to the Figures and particularly to FIG. 8 and FIG. 11, a Memory Operations Block 62 provides smart memory operations to implement higher level data structures such as hash tables and queues in the off chip memory 6.

One or more of the following smart memory operations are supported by the second version 42:
SmartMemRead (0000 0xxx)
SmartMemWrite (0000 1xxx)
SmartMemWriteAck (0001 0xxx)
SmartMemHashMapGet (01100000)
SmartMemiHashMapPut (0110 0001)
SmartMemHashMapRemove (0110 0010)
SmartMemHashMapRemoveAck (0110 0011)
SmartMemAddByte (1010 0000)
SmartMemAddHalfWord (1010 0001)
SmartMemAddWord (1010 0010)

A memory controller interface block 64 interfaces the two MCU channels to one or more other request decoder blocks. The memory controller interface block splits the transactions to the memory controller unit so that the load on each channel is balanced. In addition, the memory controller interface block optionally keeps track of outstanding requests for each channel. The memory controller interface block may also optionally maintain read response buffers for out of order responses and reassembly of the split transactions.

The blocks that require communication with another on chip block may send request to one or more transaction encoder blocks. These requests are then encoded in OCC packet format and sent to the relevant module over TX links.

Referring now generally to the Figures and particularly to FIG. 8, the DCM module 14 communicates with the other chip modules using the Ring Interconnect bus. The Ring Interconnect Rx block (“RIRB”) 64 implements the receive portion of the Ring Interconnect interface. The customization done to the RIRB 64 includes size of Request Queues and selection of Response destinations. The Packet DMA block may be the only block that expects responses from the other modules.

A transaction decoder block 66 (“TDB”) is a component of the RIRB 64. The TDB 66 decodes the requests from the Ring Bus and sends the appropriate commands to the other blocks for further processing.

The interface to the TDB block 66 is shown in the Table 1. The data is transferred in 64-bit chunks. The first assertion of the dcm_rirb_rx_data_v signal signals the start of an OCC transaction transfer. The end bf a transaction is signaled by the assertion of dcm_rirb_rx_data_last signal along with dcm_rirb_rx_data_v signal. The dcm_rirb_rx_data is valid for each cycle in which dcm_rirb_rx_data_v is asserted. The transaction decoder can stall the data transfer at any time by asserting dcm_tdb_rirb_stall in which case the dcm_rirb block will continue to hold the same data during next cycle.

TABLE 1
TDB Interface

| Signal | Width | From | To | Description |
|---|---|---|---|---|
| dcm_rirb_rx_data | 64 | dcm_rirb | dcm_tdb | OCC transaction data |
| dcm_rirb_rx_data_v | 1 | dcm_rirb | dcm_tdb | OCC transaction data is valid |
| | | | | this cycle |
| dcm_rirb_rx_data_last | 1 | dcm_rirb | dcm_tdb | OCC transaction data ends this |
| | | | | cycle. This signal is only valid |
| | | | | when dcm_rirb_rx_data_v is |
| | | | | asserted. |
| dcm_tdb_rirb_stall | 1 | dcm_tdb | dcm_rirb | tdb cannot accept data this cycle. |
| sdu_tdb_data | 64 | sdu_tdb | multiple | The data bus carrying actual |
| | | | | data. Only valid when |
| | | | | sdu_tdb_data_v is asserted. |
| sdu_tdb_last | 1 | sdu_tdb | multiple | Last cycle of command. Only |
| | | | | valid when sdu_tdb_xxxx_v is |
| | | | | asserted. |
| sdu_tdb_pgbqb_v | 1 | sdu_tdb | sdu_pgbqb | Command is valid. Signals start |
| | | | | of command to the PGBQ block |
| sdu_pgbqb_tdb_stall | 1 | sdu_pgbqb | sdu_tdb | PGBQB request to repeat current |
| | | | | cycle data. |
| sdu_tdb_pdb_v | 1 | sdu_tdb | sdu_pdb | Command is valid. Signals start |
| | | | | of command to the PDB |
| sdu_pdb_tdb_stall | 1 | sdu_pdb | sdu_tdb | PDB request to repeat current |
| | | | | cycle data. |
| sdu_tdb_ftmb_v | 1 | sdu_tdb | sdu_ftmb | Command is valid. Signals start |
| | | | | of command to the FTMB |
| sdu_ftmb_tdb_stall | 1 | sdu_ftmb | sdu_tdb | FTMB request to repeat current |
| | | | | cycle data. |
| sdu_tdb_mopb_v | 1 | sdu_tdb | sdu_mopb | Command is valid. Signals start |
| | | | | of command to the MOPB |
| sdu_mopb_tdb_stall | 1 | sdu_mopb | sdu_tdb | MOPB request to repeat current |
| | | | | cycle data. |

The TDB starts decoding the transaction when the TDB receives the first data word. An internal counter of the TDB is reset at the start of the decode and is incremented for each word the TDB receives. The decoding process is primarily controlled by the first word and second word of the transaction, which contains the destination address, opcode and the counter value. The opcodes handled by the decoder block are shown in Table: 2.

TABLE 2
TDEC Opcodes

| Opcode | Destination Block |
|---|---|
| DCM_PGBQEnqueue | PGBQB |
| DCM_PGBQDequeue | PGBQB |
| DCM_PGBQReadAttr | PGBQB |
| DCM_PGBQWriteAttr | PGBQB |
| (Smart) Memory | MOB |
| Operations on DRAM. | |
| DCM_DMA_A_E | PDB |
| DCM_DMA_A_Lin | PDB |
| DCM_DMA_E_A | PDB |
| DCM_DMA_Lin_A | PDB |
| DCM_PB_Read | PDB |

A command from the TDB block 66 to the PGBQB, PDB, FTMB or MOPB block can take one or more cycles. A command starts with the assertion of dcm_tdb_xxx_v and ends with the assertion of dcm_tdb_last. The OCC packet data is transferred from TDB on the dcm_tdb_data bus qualified by the dcm_tdb_xxxx_v signal. The intended block can hold off accepting new commands by asserting dcm_xxxx_tdb_stall.

The Ring Interconnect Tx block (RITB) 64 implements the transmit portion of the Ring Interconnect interface. There are three instances of the RITB, wherein each instance caters to one TX Link. One Tx link may be dedicated to the IOM0 to ensure low latency high traffic path for the egress packet data. The other two Tx links connect to CPMs in clockwise and anti-clockwise route. These two Tx links have balanced traffic due to symmetry of processing on CPMs.

The PGBQ block (“PGBQB”) contains the logic to implement the PGBQ 26 functionality. The PGBQB supports one or more of the following operations:
Enqueue: Enqueue a set of packet pointers onto given set of PGBQs 26 while preparing and maintaining PGBs 22.
Dequeue: Dequeue a PGB 22 from a PGBQ 26.
Read PGBQ state: read PGBQ state for a particular PGBQ 26.
Write PGBQ state: write PGBQ state for a particular PGBQ 26.

Referring now generally to the Figures and particularly to FIG. 9, a PGBQB State machine is used for implementing these operations. The PGBQB has an SRAM memory block, which holds the state, the A region and the B region for each PGBQ and the PGB cache. A PGBQB SRAM Memory stores the PGBQ state, PGB entry for write cache and two cached regions for each of the 96 PGBQs 46.

A State SRAM holds the queue state. There can be a total of 96 PGBQs 46. For each PGBQ, a set of registers is stored in the SRAM. The registers are described in Table 3.

TABLE 3
PGBQ Registers

| Name | Width | Description |
|---|---|---|
| PGBQ_BEGIN_ADDR | 28 | Beginning address |
| | | of PGBQ in DRAM |
| | | (64 byte aligned address forcing |
| | | lower 6 bits to be 0. The size of |
| | | register can be further reduced if |
| | | we constrain that PGBQ region |
| | | should always be the first |
| | | region in the RLDRAMs) |
| PGBQ_STATUS | 4 | Status bits Bit 0 = Pending |
| | | Dequeue request |
| | | Bit 1 = Read Region |
| | | Bit 2 = Write Region |
| | | Bit 3 = Overflow |
| PGBQ_MAX_ENTRIES | 16 | Maximum number of entries in |
| | | PGBQ |
| PGB_WRITE_INDEX | 8 | Write Index pointer in the PGB |
| | | Cache |
| PGBQ_READ_INDEX | 16 | Current Read Pointer |
| PGBQ_WRITE_INDEX | 16 | Current Write Pointer |

The registers take up a total of 11 bytes. Assuming a 128-bit wide SRAM and allocating 16 bytes per PGBQ, it takes accesses to retrieve the complete PGBQ state. The total memory used is (16*96)=1536 bytes.

A PGBQB SRAM holds two region blocks for each of the PGBQs 46. Each region block is 32 bytes and contains eight PGB pointer entries. The lower bits of the PGBQ_READ_INDEX and the PGBQ_WRITE_INDEX act as pointers to point to entry within the block while PGBQ number is used to select a particular block in this area. Update of this block is mentioned in the State machine section. The total memory used is 96*2*32=6144 Bytes

A PGB cache SRAM area holds PGB entry for the Enqueue command. The packet pointers provided with the command are written to this area. Once the Cache is full, it is written to DRAM. If Dequeue command is detected before cache full condition and cached entries are the only entries in the PGBQ, then current set of entries are sent to IOM. The total memory used is 96 times 128 Bytes, or 12288 Bytes. The PGB cache SRAM size is therefore 19968 Bytes.

TABLE 4
PGBQ SRAM Interface

| Signal | Width | From | To | Description |
|---|---|---|---|---|
| pgbq_sram_rd_data | 128 | pgbq_sram | multiple | Read data from the PGBQ sram |
| pgbq_sm_sram_data | 128 | pgbq_sm | pgbq_sram | Write Data from State machine |
| pgbq_sm_sram_addr | 9 | pgbq_sm | pgbq_sram | Write Address from State |
| | | | | machine |
| pgbq_sm_sram_rwn | 1 | pgbq_sm | pgbq_sram | 0 = Write 1 = Read |
| pgbq_sm_sram_cmd_v | 1 | pgbq_sm | pgbq_sram | Command is valid signal |
| pgbq_sram_sm_done | 1 | pgbq_sram | pgbq_sm | Data transfer between SRAM and |
| | | | | SM done |
| pgbq_rgnb_sram_data | 128 | pgbq_rgnb | pgbq_sram | Write Data from RGNB |
| pgbq_rgnb_sram_addr | 9 | pgbq_rgnb | pgbq_sram | Write Address from RGNB |
| pgbq_rgnb_sram_rwn | 1 | pgbq_rgnb | pgbq_sram | 0 = Write 1 = Read |
| pgbq_rgnb_sram_cmd_v | 1 | pgbq_rgnb | pgbq_sram | Command is valid signal |
| pgbq_sram_rgnb_done | 1 | pgbq_sram | pgbq_rgnb | Data transfer between SRAM and |
| | | | | RGNB done |
| pgbq_pgbmgr_sram_data | 128 | pgbq_pgb | pgbq_sram | Write Data from PGB_MGR |
| | | mgr | | |
| pgbq_pgbmgr_sram_addr | 9 | pgbq_pgb | pgbq_sram | Write Address from PGB_MGR |
| | | mgr | | |
| pgbq_pgbmgr_sram_rwn | 1 | pgbq_pgb | pgbq_sram | 0 = Write 1 = Read |
| | | mgr | | |
| pgbq_pgbmgr_sram_cmd_v | 1 | pgbq_pgb | pgbq_sram | Command is valid signal |
| | | mgr | | |
| pgbq_sram_pgbmgr_done | 1 | pgbq_sram | pgbq_pgb | Data transfer between SRAM and |
| | | | mgr | PGB_MGR done |

A PGBQB Region Block (“PGBQB_RGNB”) interfaces to one or more PGBQ state machines to carry out PGBQ region related commands. The state machines send requests to read and write PGBQ regions to the Region Block. The PGBQB_RGNB block can process one request at a time from the state machine. The interface between the PGBQB_RGNB and the PGBQB_SM blocks is shown in Table 5: PGBQB_RGN Interface. The different command types accepted by the PGBQB_RGNB block as indicated by the pgbqb_smb_rgnb_rwn are as below:
1. ReadRegion: This command reads a region from external RAM and updates it in the internal SRAM. The completion is indicated to state machine.

2. WriteRegion: This command writes the indicated region to the external RAM and indicates completion of the operation to state machine.

TABLE 5
PGBQB_RGN Interface

| Signal | Width | From | To | Description |
|---|---|---|---|---|
| pgbq_smb_rgnb_addr | 32 | pgbq_sm | pgbq_rgnb | Region begin address |
| pgbq_smb_rgnb_index | 8 | pgbq_sm | pgbq_rgnb | Region index |
| pgbq_smb_rgnb_rwn | 1 | pgbq_sm | pgbq_rgnb | 0 = Write; 1 = Read |
| pgbq_smb_rgnb_cmd_v | 1 | pgbq_sm | pgbq_rgnb | Command is valid |
| pgbq_rgnb_smb_done | 1 | pgbq_rgnb | pgbq_sm | Command is done |
| pgbq_sram_rd_data | 128 | pgbq_sram | multiple | Read data from the PGBQ sram |
| pgbq_rgnb_sram_data | 128 | pgbq_rgnb | pgbq_sram | Write Data from State machine |
| pgbq_rgnb_sram_addr | 9 | pgbq_rgnb | pgbq_sram | Write Address from State |
| | | | | machine |
| pgbq_rgnb_sram_rwn | 1 | pgbq_rgnb | pgbq_sram | 0 = Write 1 = Read |
| pgbq_rgnb_sram_cmd_v | 1 | pgbq_rgnb | pgbq_sram | Command is valid signal |
| pgbq_sram_rgnb_done | 1 | pgbq_sram | pgbq_rgnb | Data transfer between SRAM |
| | | | | and SM done |
| rgnb_mci_addr | 28 | pgbq_rgnb | sdu_mcib | Address of the external Memory |
| rgnb_mci_dest | 3 | pgbq_rgnb | sdu_mcib | 3 bit destination where read data |
| | | | | to be delivered (fixed for this |
| | | | | interface) |
| rgnb_mci_tag | n | pgbq_rgnb | sdu_mcib | n bit tag returned with read data |
| | | | | by MCI |
| rgnb_mci_wr_data | 128 | pgbq_rgnb | sdu_mcib | Write Data |
| rgnb_mci_rwn | 1 | pgbq_rgnb | sdu_mcib | 0 = Write; 1 = Read |
| pgbq_rgnb_mci_cmd_v | 1 | pgbq_rgnb | sdu_mcib | Command is valid |
| pgbq_mcib_rgnb_done | 1 | sdu_mcib | pgbq_rgnb | Command is done |
| mci_rgnb_rd_data | 128 | sdu_mcib | pgbq_rgnb | Write Data |

The operation of a PGBQB state machine is now discussed. There are four branches to the state machine taken depending on the command and current state of the queue, namely:
Enqueue State machine: When there is no pending Dequeue request on the queue and one of the CPMs issues an Enqueue command to the PGBQ;
Dequeue State machine: When IOM0 issues a Dequeue command to a PGBQ that is not empty;
Pending Dequeue State Machine: When IOM0 requests a Dequeue on an empty PGBQ; and
Direct Dequeue State Machine: When Enqueue command is issued to a PGBQ where Dequeue is already pending on the PGBQ

The branching may be done after a common MEM_RD_0 state, which loads the current state of the PGBQ.

Referring now generally to the Figures and particularly FIG. 10, to the PGBQB State machine is illustrated in FIG. 10. Common states of the PGBQ state machine may include one or more of the following states:
IDLE: Wait until valid command is detected or if current Enqueue is complete. The commands supported are Enqueue, Dequeue, ReadState and WriteState. The PGBQ parameter from the Packet is sent to PGBQ SRAM block for loading the PGBQ state for the requested Queue.
LOAD_PGBQ_STATE: Waits until the queue state is retrieved from the PGBQB SRAM. Branching to the next state, depending on the operation requested and the current PGBQ state, occurs when the memory access is complete. The following are at least some of the possible branches taken from this state:
   1. Enqueue on a full queue is reported as overflow. A queue is considered full if read pointer and write pointer are identical and are present in different regions of the cache, in which case the request is discarded and overflow flag is set and transition is made to STORE_PGBQ_STATE.
   2. Enqueue on a queue with pending Dequeue request bypasses all the Enqueue and Dequeue state manipulations and delivers the packet pointers to the Packet Composer for sending it to IOM0. Pending flag is cleared and Control is transferred to the STORE_PGBQ_STATE.
   3. Enqueue operations other than this may require the PGBQ region entry pointed by the PGBQ_WRITE_INDEX, to be written. The SRAM entries are 128 bits which needs read-modify-write to be performed to update a 32 bit value. A read for this entry is initiated on the PGBQ SRAM block. The control is then transferred to the ENQ_ST_0 state
   4. Dequeue on an empty queue (PGBQ is empty and PGB_WRITE_INDEX is zero) is marked as pending in the status flags. No other action is required.
   5. Dequeue on a non-empty queue needs the entry of PGBQ where the PGBQ_READ_INDEX points. A read for this entry is initiated on the PGBQ SRAM block. The control is then transferred to the DQ_ST_0 state
   6. If ReadState command is detected the read state is sent to the Packet Composer and transition is made to IDLE
   7. If WriteState command is detected, the state variables are updated from the OCC data and transition is made to STORE_PGBQ_STATE.
STORE_PGBQ_STATE: Each state machine ends in this state after completing assigned task. The state variables are written back to the SRAM and an unconditional jump is made to IDLE after completion of the write.

PGBQB Enqueue State Machine:
ENQ_ST_0: Depending on PGB_WRITE_INDEX number of PGB entries that can be sent to PGB write cache is determined. A PGB cache write is generated for these entries. The PGB_WRITE_INDEX is modified to reflect the update of cache. The packet pointer count for current PGBQ is updated. The transition is made to ENQ_ST_1.
ENQ_ST_1: If PGB_WRITE_INDEX has reached maximum then the cache write to the off-chip memory operation is started at PGB_MGR and transition is made to ENQ_ST_2. Otherwise if a packet_pointer count for a current PGBQ is non-zero an ENQ_ST_0 value is entered again. If the pointer reaches zero transition is made to STORE_PGBQ_STATE.
ENQ_ST_2: The PGB_MGR on completion returns an off-chip pointer. The PGB_WRITE_PTR is reset. The PGB entry is written in location pointed by the PGBQ_WRITE_INDEX and SRAM update is triggered. A check is made to see if the next write address is going to be in a new region. This is done by comparing lower bits of the PGBQ_WRITE_INDEX. If PGBQ_READ_INDEX and PGBQ_WRITE_INDEX are within same block then the other region block is assumed to be free and PGBQ_WRITE_INDEX is modified to point to the free block and next state ENQ_ST_3 is made. In case the two indices point to different blocks, current region block has to be written to external RAM. A command to PGBQB Region Block is made to this effect and state ENQ_WR_WT_0 is entered. If the PGBQ_WRITE_INDEX is not pointing to last entry of the region, it is incremented to point to next location in the region block and transition to ENQ_ST_3 is made.
EQ_WR_WT_0: After completing the write operation to external SRAM this state restores the PGBQ_WRITE_INDEX to beginning of the current region block and transition is made to ENQ_ST_3 state.
ENQ_ST_3: If packetpointer count for current PGBQ is checked, if it is non-zero ENQ_ST_0 is entered again. If the pointer reaches to zero transition is made to STORE_PGBQ_STATE.

PGBQB Dequeue State Machine:
DQ_ST_0: If the PGBQ is empty and PGB_WRITE_INDEX is not zero, Cache is sent to the Packet Composer. The PGB_WRITE_INDEX is reset to zero and transition is made to STORE_PGBQ_STATE. If the PGBQ is not empty, then the PGB entry is read from the PGBQ_READ_INDEX location and sent to Packet Composer for reading it from the external RAM and sending it to IOM0. A check is made to see if the next read address is going to be in a new region. This is done by comparing lower bits of the PGBQ_READ_INDEX. If NEXT_PGBQ_READ_INDEX and PGBQ_WRITE_INDEX are within same block then the other region block is assumed valid and PGBQ_READ_INDEX is modified such that it points to the other block and next state EQ_ST_1 is made. In case the two indices point to different blocks, current region block has to be read from external RAM. A command to PGBQB Region Block is made to this effect and state DQ_RD_WT_0 is entered. If the PGBQ_READ_INDEX is not pointing to last entry of the region, it is incremented to point to next location in the region block and transition to DQ_ST_1 is made.
DQ_RD_WT_0: After completing the read operation from external SRAM, this state restores the PGBQ_READ_INDEX to beginning of the current region block and transition is made to DQ_ST_1 state.
DQ_ST_1: Waits until transfer of PGB data to Packet Composer is complete. The control is transferred to next state STORE_PGBQ_STATE.

The PGBQ_SM interface is shown in Table 6: PGBQ_SM Interface

TABLE 6
PGBQ_SM Interface

| Signal | Width | From | To | Description |
|---|---|---|---|---|
| sdu_tdb_data | 32 | sdu_tdb | multiple | The data bus carrying actual |
| | | | | data. Only valid when |
| | | | | sdu_tdb_data_v is asserted. |
| sdu_tdb_last | 1 | sdu_tdb | multiple | Last cycle of command. Only |
| | | | | valid when sdu_tdb_xxxx_v is |
| | | | | asserted. |
| sdu_tdb_pgbqb_v | 1 | sdu_tdb | sdu_pgbqb | Command is valid. Signals start |
| | | | | of command to the PGBQ block |
| sdu_pgbqb_tdb_stall | 1 | sdu_pgbqb | sdu_tdb | PGBQB request to repeat current |
| | | | | cycle data. |
| pgbq_sram_rd_data | 128 | pgbq_sram | multiple | Read data from the PGBQ sram |
| pgbq_sm_sram_data | 128 | pgbq_sm | pgbq_sram | Write Data from State machine |
| pgbq_sm_sram_addr | 9 | pgbq_sm | pgbq_sram | Write Address from State |
| | | | | machine |
| pgbq_sm_sram_rwn | 1 | pgbq_sm | pgbq_sram | 0 = Write 1 = Read |
| pgbq_sm_sram_cmd_v | 1 | pgbq_sm | pgbq_sram | Command is valid signal |
| pgbq_sram_sm_done | 1 | pgbq_sram | pgbq_sm | Data transfer between SRAM |
| | | | | and SM done |
| pgbq_smb_rgnb_addr | 32 | pgbq_sm | pgbq_rgnb | Region begin address |
| pgbq_smb_rgnb_index | 8 | pgbq_sm | pgbq_rgnb | Region index |
| pgbq_smb_rgnb_rwn | 1 | pgbq_sm | pgbq_rgnb | 0 = Write; 1 = Read |
| pgbq_smb_rgnb_cmd_v | 1 | pgbq_sm | pgbq_rgnb | Command is valid |
| pgbq_rgnb_smb_done | 1 | pgbq_rgnb | pgbq_sm | Command is done |
| pgbq_smb_pcb_da | 32 | pgbq_sm | pgbq_pcb | DA field of the OCC packet |
| pgbq_smb_pcb_sop | 8 | pgbq_sm | pgbq_pcb | SOP field of the OCC packet |
| pgbq_smb_pcb_dop | 8 | pgbq_sm | pgbq_pcb | DOP field of the OCC packet |
| pgbq_smb_pcb_len | 8 | pgbq_sm | pgbq_pcb | Length of Payload field of the |
| | | | | OCC packet |
| pgbq_smb_pcb_sa | 32 | pgbq_sm | pgbq_pcb | SA field of the OCC packet |
| pgbq_smb_pcb_stp | 1 | pgbq_sm | pgbq_pcb | 0 = PGB; 1 = State |
| gbn | | | | |
| pgbq_smb_pcb_state | 128 | pgbq_sm | pgbq_pcb | State of selected PGBQ |
| pgbq_smb_pcb_PGB | 32 | pgbq_sm | pgbq_pcb | PGB pointer for Dequeue |
| | | | | operation |
| pgbq_smb_pcb_v | 1 | pgbq_sm | pgbq_pcb | Command Valid |
| pgbq_pcb_smb_stall | 1 | pgbq_pcb | pgbq_sm | Not ready to accept command |

A PGBQB packet composer block (“PGBQ_PCB”) receives the PGB address 22B or partial PGB information for a Dequeue command or the state information for the PGBQ 26 from the state machine. In case of the PGQ address, PGBQ_PCB sends the OCC header information to the IOM0 TEB and acquires a token from the IOM0 TEB. The token is then passed to the Memory controller interface along with the request to fetch the PGB. The MCIB is instructed to send the data directly to the TEB of IOM0. The PGB is then released to the Packet Buffer FreeList once the Read request is posted to the MCU (indicated by the mci_clear signal). In case of StatusRead response, the PGBQ_PCB looks at the destination field of the Packet to be formed and selects the TEB accordingly. The PGBQ_PCB then sends the information to the TEB indicating that the data should be picked up from the IP immediately the TEB does not issue a token for such request. The interface of the Packet Composer is shown in Table 7: PGBQ_PCB Interface.

TABLE 7
PGBQ_PCB Interface

| Signal | Width | From | To | Description |
|---|---|---|---|---|
| pgbq_smb_pcb_da | 32 | pgbq_sm | pgbq_pcb | DA field of the OCC packet |
| pgbq_smb_pcb_sop | 8 | pgbq_sm | pgbq_pcb | SOP field of the OCC packet |
| pgbq_smb_pcb_dop | 8 | pgbq_sm | pgbq_pcb | DOP field of the OCC packet |
| pgbq_smb_pcb_len | 8 | pgbq_sm | pgbq_pcb | Length of Payload field of the |
| | | | | OCC packet |
| pgbq_smb_pcb_sa | 32 | pgbq_sm | pgbq_pcb | SA field of the OCC packet |
| pgbq_smb_pcb_stp | 1 | pgbq_sm | pgbq_pcb | 0 = PGB; 1 = State |
| gbn | | | | |
| pgbq_smb_pcb_state | 128 | pgbq_sm | pgbq_pcb | State of selected PGBQ |
| pgbq_smb_pcb_PGB | 32 | pgbq_sm | pgbq_pcb | PGB pointer for Dequeue |
| | | | | operation |
| pgbq_smb_pcb_v | 1 | pgbq_sm | pgbq_pcb | Command Valid |
| pgbq_pcb_smb_stall | 1 | pgbq_pcb | pgbq_sm | Not ready to accept command |
| pgbq_pcb_data | 128 | pgbq_pcb | multiple | goes to all the TEBs |
| pgbq_pcb_tebiom0_da | 32 | pgbq_pcb | sdu_tebiom0 | DA field of the OCC packet |
| pgbq_pcb_tebiom0_sop | 8 | pgbq_pcb | sdu_tebiom0 | SOP field of the OCC packet |
| pgbq_pcb_tebiom0_dop | 8 | pgbq_pcb | sdu_tebiom0 | DOP field of the OCC packet |
| pgbq_pcb_tebiom0_len | 8 | pgbq_pcb | sdu_tebiom0 | Length of Payload field of the |
| | | | | OCC packet |
| pgbq_pcb_tebiom0_sa | 32 | pgbq_pcb | sdu_tebiom0 | SA field of the OCC packet |
| pgbq_pcb_tebiom0_mipn | 1 | pgbq_pcb | sdu_tebiom0 | 1 = data from RLDRAM; 0 = data |
| | | | | from IP |
| pgbq_pcb_tebiom0_v | 1 | pgbq_pcb | sdu_tebiom0 | Command Valid |
| pgbq_tebiom0_pcb_done | 1 | sdu_tebiom0 | pgbq_pcb | Command Done |
| pgbq_tebiom0_pcb_tag | n | sdu_tebiom0 | pgbq_pcb | Tag for forwarding memory data |
| | | | | transaction. Valid with done bit |
| | | | | only |
| pgbq_pcb_tebtx0_da | 32 | pgbq_pcb | sdu_tebtx0 | DA field of the OCC packet |
| pgbq_pcb_tebtx0_sop | 8 | pgbq_pcb | sdu_tebtx0 | SOP field of the OCC packet |
| pgbq_pcb_tebtx0_dop | 8 | pgbq_pcb | sdu_tebtx0 | DOP field of the OCC packet |
| pgbq_pcb_tebtx0_len | 8 | pgbq_pcb | sdu_tebtx0 | Length of Payload field of the |
| | | | | OCC packet |
| pgbq_pcb_tebtx0_sa | 32 | pgbq_pcb | sdu_tebtx0 | SA field of the OCC packet |
| pgbq_pcb_tebtx0_mipn | 1 | pgbq_pcb | sdu_tebtx0 | 1 = data from RLDRAM; 0 = data |
| | | | | data from IP |
| | | | | Should be always 0 for TEB for |
| | | | | TX0 |
| pgbq_pcb_tebtx0_v | 1 | pgbq_pcb | sdu_tebtx0 | Command Valid |
| pgbq_tebtx0_pcb_done | 1 | sdu_tebtx0 | pgbq_pcb | Command Done |
| pgbq_tebtx0_pcb_tag | n | sdu_tebtx0 | pgbq_pcb | Tag for forwarding memory data |
| | | | | transaction. Valid with done bit |
| | | | | only; Not required for TEB for |
| | | | | TX0, provided for logical |
| | | | | completeness |
| pgbq_pcb_tebtx1_da | 32 | pgbq_pcb | sdu_tebtx1 | DA field of the OCC packet |
| pgbq_pcb_tebtx1_sop | 8 | pgbq_pcb | sdu_tebtx1 | SOP field of the OCC packet |
| pgbq_pcb_tebtx1_dop | 8 | pgbq_pcb | sdu_tebtx1 | DOP field of the OCC packet |
| pgbq_pcb_tebtx1_len | 8 | pgbq_pcb | sdu_tebtx1 | Length of Payload field of the |
| | | | | OCC packet |
| pgbq_pcb_tebtx1_sa | 32 | pgbq_pcb | sdu_tebtx1 | SA field of the OCC packet |
| pgbq_pcb_tebtx1_mipn | 1 | pgbq_pcb | sdu_tebtx1 | 1 = data from RLDRAM; 0 = data |
| | | | | from IP |
| | | | | Should be always 0 for TEB for |
| | | | | TX1 |
| pgbq_pcb_tebtx1_v | 1 | pgbq_pcb | sdu_tebtx1 | Command Valid |
| pgbq_tebtx1_pcb_done | 1 | sdu_tebtx1 | pgbq_pcb | Command Done |
| pgbq_tebtx1_pcb_tag | n | sdu_tebtx1 | pgbq_pcb | Tag for forwarding memory data |
| | | | | transaction. Valid with done bit |
| | | | | only; Not required for TEB for |
| | | | | TX1, provided for logical |
| | | | | completeness |
| pcb_mci_addr | 28 | pgbq_pcb | sdu_mcib | Address of the external Memory |
| pcb_mci_dest | 3 | pgbq_pcb | sdu_mcib | 3 bit destination where read data |
| | | | | to be delivered |
| pcb_mci_tag | n | pgbq_pcb | sdu_mcib | n bit tag returned with read data |
| | | | | by MCI |
| pcb_mci_wr_data | 128 | pgbq_pcb | sdu_mcib | Write Data |
| pcb_mci_rwn | 1 | pgbq_pcb | sdu_mcib | 0 = Write; 1 = Read |
| pgbq_pcb_mci_cmd_v | 1 | pgbq_pcb | sdu_mcib | Command is valid |
| pgbq_mcib_pcb_done | 1 | sdu_mcib | pgbq_pcb | Command is done |
| mci_pcb_rd_data | 128 | sdu_mcib | pgbq_pcb | Write Data |

Referring now generally to the Figures and particularly to FIG. 11 and FIG. 12, FIG. 11 illustrates a Packet DMA Block 68. A DMA Arbitration block 70 pulls requests from a Resource queue 72. Depending on the type, the request is sent to one of the AtoEBlocks 74, EtoABlock 76, or Packet Buffer Read Block 78.

There are multiple instances of AtoEBlock 74 considering longer processing time and the amount of traffic throughput required (All egress packets and packets for temporary storage)

The is single EtoABlock 76 is sufficient as the traffic required is much less (Temporary storage packets)

There is single instance of Packet Buffer Read Block 78 since the processing requirement is modest.

The AtoEBlock 74 supports two commands AtoE conversion and AtoLin conversion. The data from CPM memory 16 that was stored in “A” formatted packet is moved to off chip memory. The storage format for off chip can be E1/E2 or as linear storage.

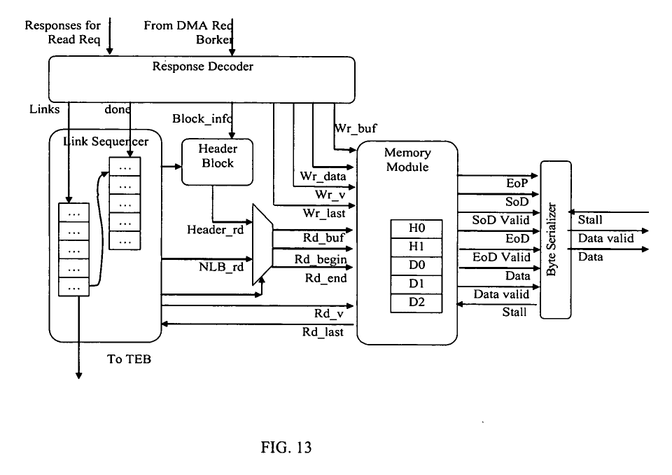

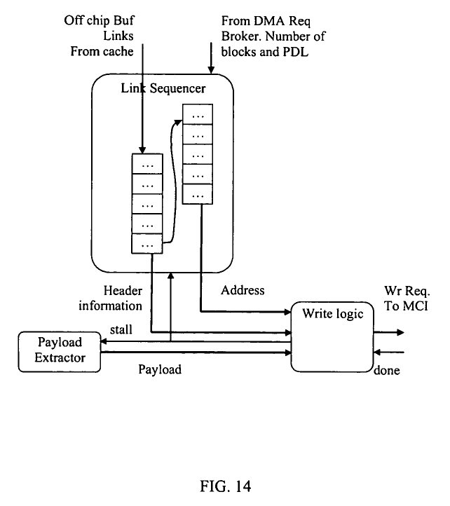

Referring now generally to the Figures and particularly to FIG. 11, FIG. 12, FIG. 13 and FIG. 14, FIG. 12 illustrates the process of sending a packet DMA to an off chip destination. A DMA request broker 80, after detecting an A-to-E conversion request, allocates number of free off chip buffers. The DMA request broker 80 then sends the first header buffer to the TEB for fetching the corresponding packet from CPM Memory 18. The destination address of the transaction is set to a Response decoder 82 so that further process is taken over by the Response decoder 82. The “A” packet parser indicates completion of the packet to the Response decoder 82, which in turn indicates the same to the DMA request broker 80. The DMA Request broker 80 then publishes the pointer of E packet or indicates completion of transfer to linear area.

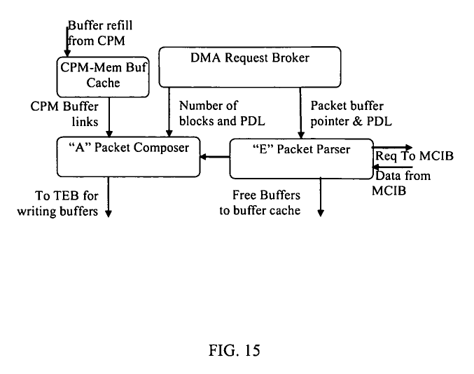

Referring now generally to the Figures and particularly to FIG. 13, FIG. 14 and FIG. 15, FIG. 15 illustrates an A parser. The pointer to first header buffer is passed to the A parser with an indication that this is start of the packet. The information on number of packet buffers required off chip and type of packet for off chip storage is computed and passed to an E composer. A start of Packet may also be indicated to the E composer. The selected Pipe is then assumed busy until the pipe indicates completion. The E composer may have a special mode where the data is not stored in E format but at linear address. The same pipe is used for this purpose. The rest of the parser processing may be similar or identical to the “A to E” processing described above.

The sub blocks of the A parser may include one or more of the following:

>Response Decoder Module 82

A response decoder module 82 decodes the destination address and sends the link buffer data to memory. The header buffer is decoded. The valid links are queued in sequence in the Link Sequencer, The SoD and EoD fields are sent to header module and the payload is copied to the memory module. An indication of completion of the transfer is sent to the Link Sequencer.

>Link Sequencer 84

A link sequencer module 84 receives the buffer links in the input queue. Each entry is marked as Header entry of NBL entry. These entries are forwarded to a Request composer as and when the space is available in the memory module. The entry is then moved to pending queue. When the response is available for the request is available and payload is written, the response decoder module informs link sequence about the same. The entry for which data is written is then marked as available. The payload for a selected buffer 22 may then be scheduled for sending to a byte lane serializer 86. If the selected Payload is from header buffer, a header module is indicated to put start and end address, for link blocks the start address is driven as “0” and the end address is computed from remaining payload and size of data buffer. A dispatcher advances on detecting last signal from the memory module. When a last byte of the packet is sent through the memory module, an eop signal is generated for clearing the pending information.

>Header Module

The header module stores the sod and the eod fields of packets. These fields are driven as start and end address when instructed by the Link Sequencer 84.

>Byte Lane Serializer 86

The byte lane serializer module takes data from Memory module. It takes 32 bit data along with sod and eod position if valid within the dowrd. It packs the data in 32 bit dwords and maintains pending data. Only restriction is if sod and eod are valid within a word the eod should not be less than sod. The packing process is reset on detection of eop signal. The eop signal may have once cycle latency. New start should not be issued for one cycle after sending eop signal.

Memory Module 88

A memory module encapsulates memory and provides a view of buffers. It recognizes two kinds of buffers viz. Two “H” Buffers of 96 Bytes each and three “D” buffers of 128 bytes each. The H buffers store the payload data of the Headers while the D buffers store the Link Buffer data.

The Write Interface consists of wr_data, wr_data_v, wr_buf, wr_last. Internally the module contains 7 bit counter indicating offset in the buffer where data is written. This offset is reset to 0 with initial reset and every time wr_last is detected. The data writing takes place every time wr_data_v is detected wr_data is written at current offset in wr_buf.

The Read Interface consists of rd_buf, rd_begin, rd_end, rd_v, rd_last, rd_data, rd_data_valid, rd_sod, rd_sod_v, rd_eod, rd_eod_v. The read is triggered by setting rd_buf to point to relevant buffer, rd_begin indicates offset within the buffer, rd_end indicates last address of the buffer, the rd_v is asserted to indicate that all above parameters are valid and read shall start. The block starts providing rd_data with rd_data_valid. The rd_sod indicates the byte position of the valid data in the word the rd_sod_v indicates the rd_sod is valid for this byte. The lower two address bits of rd_begin when internal offset matches the rd_begin indicate rd_sod. The rd_eod and rd_eod_v are similarly generated comparing internal offset and rd_end. The rd_last signal is generated by this module to indicate that it has completed the read operation.

Referring now generally to the Figures, and particularly to FIG. 14, an E composer 88 module receives the packet payload from the “A” packet parser. The E composer 88 reads the off-chip free buffer pointer from cache and stores the data in the off chip memory 6 in packet format. The sub blocks of the E composer 88 may include one or more of the following:

>Packet Buffer Sequencer 90

This module is started by the top-level transaction decoder by providing number of packet buffers and type of packet “E1” or “E2”. The module then fetches adequate number of packet buffer pointers to constructs the header of E1 or E2. The header information, including the NBLs is sent to memory controller interface for writing at header block address. The payload extractor is activated during payload area and the Data block areas. The memory address for the payload area is also provided by the packet buffer sequencer. It also supports bypass mode where E formatting is not done but a continuous address is maintained and provided to a write logic.

>Payload Extractor 92

This module interfaces with the “A” packet parser. It pulls 32 bit data from the packet payload area on instruction from Link Sequencer and forwards it to the write logic.

>Write Logic 94

The write logic module receives the 32 bit data from link sequencer or the payload extractor and associated address from the link sequencer. It assembles this information as single write request to the memory interconnect block and dispatches it.

Referring now generally to the Figures, and particularly to FIG. 15, an EtoA block 76 supports two commands EtoA conversion and LintoA conversion. The data from off-chip memory 6 (in E1/E2 or linear format) is stored in the on-chip memory 18 in “A” formatted packet. The DMA request broker 80, after detecting an E-to-A conversion request, allocates number of free CPM buffers 24. If sufficient data storage access is not present, the CPM Buffer cache 24 is instructed to fetch adequate number of buffers from the CPM FreeList 23. The first header pointer is the sent to an E packet parser 96 for fetching the data from off chip Memory. The E packet parser 96 then loads the data and sends it to “A” Packet Composer which in turn sends it to CPM for storage. The E Parser then indicates completion of the packet to the DMA request broker.

Regarding the DMA request broker 80, the pointer to the first header buffer or the linear area address is passed to the E packet parser 96. This communication also indicates that this first header is the start of the packet. In case of a LintoA command the DMA request broker 80 also sends the count information. The E packet parser 96 may include one or more of the following elements:

>Link Sequencer 98

A link sequencer block of the E parser 96 receives the first header pointer from the DMA Request broker 80. The packet buffer along with the type is forwarded to the Read logic. The Read size is kept at 128 Bytes for first header buffer. The Read Logic extracts the header information and sends it back to the Link Sequencer 98 for queuing the next links. The Link Sequencer 98 also sends the actual PDL value to the A Composer.

>Read Logic 100

A read logic block 100 of the E parser may a request to the MCI based on packet buffer address and size provided by the Link Sequencer. The received data is then split into header data, which is sent to Link Sequencer, and payload data, which is sent to a payload extractor.

>Payload Buffer 102

The payload is buffered in a payload buffer 102 for an A frame composition. The payload is delivered to an A frame composer 104 on demand. It also does flow control by using stall when TX is busy sending other information.

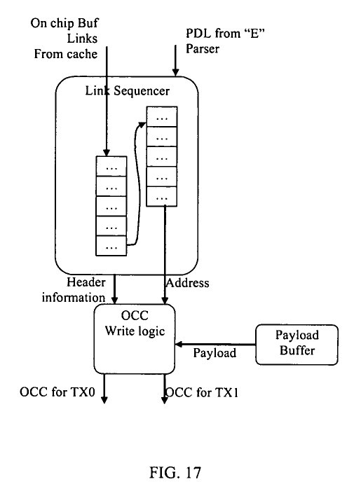

Referring now generally to the Figures and particularly to FIG. 17 several components of the A composer 104 are shown in FIG. 17, to include:

>Link Sequencer 106

A composer link sequencer module 106 that is invoked with PDL and on-chip buffer count as parameters. The relevant block then obtains the on-chip buffer pointers from the cache. The first header block is filled with information about NBLs. The NBLs are then queued in another queue for direct filling. The data for payload area is extracted from a Payload Buffer 108.

>OCC Write Logic 110

An A composer OCC write logic 112 picks up type of packet information. The link pointers and the other header information are picked up from the link sequencer 106 while the payload is received from the Payload Buffer 108. The composed packet is then forwarded to the TEB of TX0 or TX1 depending on the DA field.

An A composer packet buffer read block transfers the read request from IOM to the MCI for UnCached accesses and frees the block to the packet buffer FreeList. The detailed steps are as follows:
Construct OCC header from the request and request TEB to IOM, the data is indicated from the memory;
The TEB returns a tag. The tag along with packet buffer address and the destination of IOM TEB is sent to MCI; and
The MCIB acknowledgement indicating transfer of request to MCU is used to determine completion. On this event, the packet buffer pointer is sent for freeing.

A plurality of Packet Buffers and PGB FreeLists 23 are maintained in off chip area. The FreeList(s) 23 provide packet buffers for both the requirements. Each DCM 14v provides 8 segments (16 segments for 512 Mbit parts) of Maximum of 8 MByte memory. Each segment holds maximum of 64K packet buffers. A 16 Bit handle, along with a 3 bit (4 bits for 512 Mbit parts) segment information, uniquely identifies a packet buffer. The size of a segment must be in multiple of 64 packet buffers i.e. 8 Kbytes. The handle 0×FFFF is considered as an invalid handle. This means that in case of 8 MByte mode one of the buffers cannot be used for storing data.

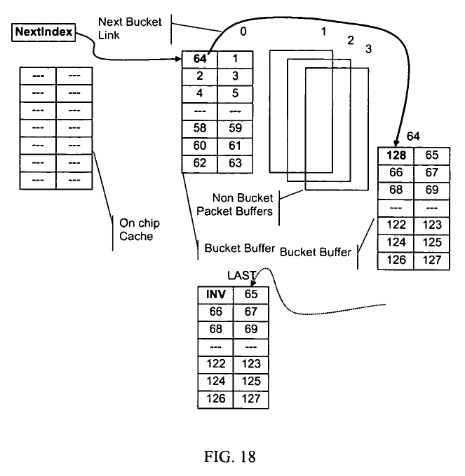

Referring now generally to the Figures and particularly to FIG. 18, a top-level FreeList manager 112 makes the segments visible as single List. The variable, Current Alloc Segment, indicates segment where allocation is happening. A 23-bit packet buffer handle retuned by this block is composed from actual off-chip memory address and the segment. The off-chip memory address is always a 128 byte-aligned address. The segment address is stored in the 4 least significant bits. The packet buffer handle is composed of a packet buffer address and the segment. The blocks that need to access the memory from the packet buffer should mask off the lower 4 bits to generate base address of the packet buffer. But the entire packet buffer handle is stored in E packet or PGBs so that the segment information is retained. The segment information is required during the free operation.

Top Level Processing may comprise one or more of the following processes and steps: Alloc Operation:
1. Check that not all the FreeLists are empty.
2. If current Alloc Segment is empty select next Alloc Segment.
3. Repeat 2 till we hit non-empty segment.
4. Pass Alloc request to the segment. Note: All further allocations will keep happening from this segment now.
5. Convert Handle to pointer using current segment settings.

Free Operation:
1. Decode address to determine which segment the packet belongs and the handle of the buffer
2. Forward the Free request to the segment.

Information maintained per FreeList segment may include the following:
1. Base Address: used for computing packet base address from handle (Must be 128 byte aligned any additional restriction will help in reducing size of adder)
2. Next Free Index: Points to next free bucket (0×FFFF is invalid handle indicates it is pointing to NULL)
3. Curr Ptr: Pointer in the Cache indicating free entry (0×00-0×80) 0×80 indicate it is pointing outside the cache and current cache is empty.

Initialization of the FreeList may be done in software. During initialization, Base Address may be set to an address of a first packet buffer in segment. The Free Bucket chain may be established in the packet buffer area. The Next Free Index may be initialized to first a Bucket of the Free Bucket of the chain. A Curr Ptr is initialized to 0×80, whereby an indicated cache is listed as empty.

When a Next Free Index equals 0×FFFF and the Curr Ptr equals 0×80, a corresponding segment is listed as completely utilized and the FreeList is empty. This condition is detected at the top level and Alloc requests are not forwarded to the segment.

The Operations are described in pseudo-code as follows:

Alloc Operation:

```
If (CurrPtr==0x80) {
    Load buffer from NextFreeInd in the Local Cache;
    Swap NextFreeInd and First Entry of the Local Cache;
    Set CurrPtr = 0x00;
    }
Send ((Entry @CurrPtr from the Cache) * 128 + Base Address);
CurrPtr++
Free Operation:
CurrPtr −−;
Store ((input − Base Address) / 128) @CurrPtr in cache;
If (CurrPtr == 0) {
    Swap NextFreeInd and First Entry from Cache;
    Write cache to NextFreeInd;
    Set CurrPtr = 0x80;
    };
```

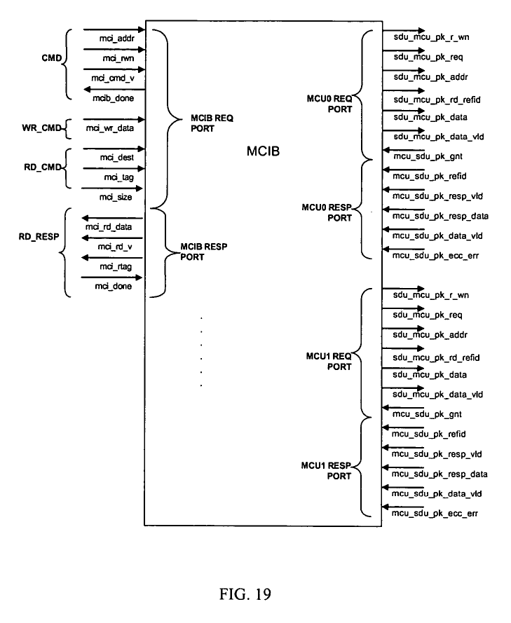

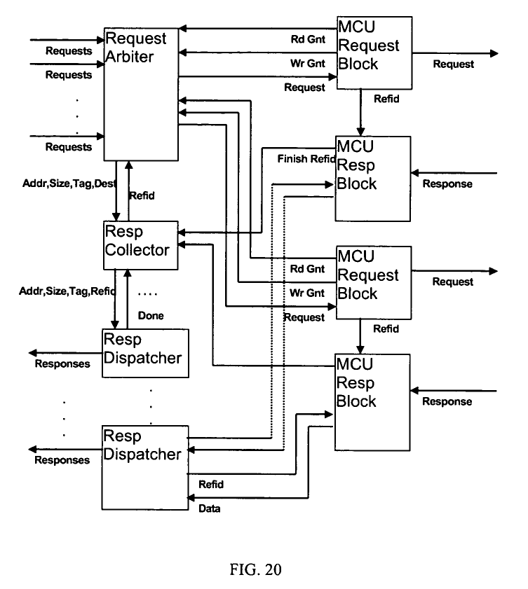

Referring now generally to the Figures and particularly to FIG. 19 and FIG. 20, are two Memory Controller Interface blocks (“MCIB”) 114. One of the MCIBs connects the Packet DMA block to the non-cached port of the MCUs while the other connects rest of the blocks to the Cached port of the MCUs. The two MCIBs 114 are identical except number of ports for SDU blocks 116.

The following description is common both the MCIBs 114. The MCIB ports 118 for SDU blocks 116 are of two types, viz. Request Ports 120 and Response Ports 122. Each block connecting to an SDU request port 120 must have a CMD connection and at least one of the WR_CMD or RD_CMD connections. The read responses are sent to the Response Ports 122. Each response port 122 has unique number and the read command indicates the response port where read data should be sent. The tag sent with the read command is returned to response port while sending data. The read data is sent in sequence on the Response Port 122. The commands send two acknowledgements mci_done and mci_clear. The mci_done is sent when the command is taken for processing and the block is allowed to post new command. The mci_clear is sent when the command is dispatched to the MCU. The mci_clear is used by the blocks that read the packet buffer and free the buffers.

A request arbiter block arbitrates MCU requests from different SDU blocks 116. The read request is given higher priority over write request. Within read and write requests the arbitration is round robin. The rationale behind giving higher priority is read is based on the following assumptions:
Each read request requires that both the request block indicate RdGnt, so there will be adequate gaps to fill write request without stalling;
Reads take more cycles before getting dispatched; and
There may be state machines waiting for read to happen

Read Request Processing

When RdGnt is available from both the channels, the read request is taken from the requestor. An entry of Lower 2 bits of address, Size of request, Destination address and Destination tag is made in the Response Collector. The response collector returns the Refid for the stored entry. This Refid is then forwarded to both the channels along with read requests for the channels. The read request for an individual channel is composed as follows:

| | | ReqSize[0] | | | |
|---|---|---|---|---|---|
| | | 0 | | 1 | |
| ReqAddr[0] | | Address | Size | Address | Size |
| 0 | Channel 0 | Addr/2 | Size/2 | Addr/2 | (Size/2) + 1 |
| | Channel 1 | Addr/2 | Size/2 | Addr/2 | Size/2 |
| 1 | Channel 0 | (Addr/2) + | Size/2 | (Addr/2) + | Size/2 |
| | | 1 | | 1 | |
| | Channel 1 | Addr/2 | Size/2 | Addr/2 | (Size/2) + 1 |

Channel 0 Address=ReqAddr[22:1]+ReqAddr[0]

Channel 0 Size=ReqSize[7:1]+(ReqSize[0]& !ReqAddr[0])

Channel 1 Address=ReqAddr[22:1]

Channel 1 Size=ReqSize[7:1]+(!ReqSize[0]& ReqAddr[0])

Write Request Processing

The Write Request to this block are all 16 byte requests. The arbitration logic checks for WrGnt from the channel indicated by the ReqAddr[0]. If the WrGnt is available, the write is handed over to the Channel.

A response collector block plays main role in the read request handling. It supports maximum 32 outstanding requests. It maintains three resources to consolidate responses of the requests.

Refid FreeList

A 32-bit register acts as a FreeList of Refids. On allocation request to FreeList position a first 0 is returned as Refid and the bit is set. The free request clears the bit at position indicated by the Refid.

Req Info Array

A req info array provides a 32-entry array that is maintained in a register file. The array may be indexed with Refid. Each entry in the array contains the following fields;
Destination
Tag
Size
Lower “n” bits of the address

Finish List

A finish list comprises a set of 64 flops arranged in two rows of 32 flops. Each flop indicates a response status completion. The two rows indicate two channels. The bits are set on receipt of completion status from the channel response blocks. A separate logic finds completed requests and dispatches them to request dispatcher based on destination field stored in Req Info Array. All these bits are cleared during initialization and on transfer of response data to SDU blocks.

>Algorithms in Response Collector Block

The Request block generates an allocation request to this block when read request is detected. An entry is allocated in the Refid FreeList. The information regarding the read request is then stored in the Req Info Array. When all the data for a given request is collected the MCU Response Blocks indicate a completion to this block. The Finish list bits are set based on this information. The finish list is scanned continuously to find next completion. If completion is detected on both the channels for requests, the entry in the Req Info Array is pulled out. The destination field in the information is decoded. Rest of the entry along with Refid is passed to Request Dispatcher. The dispatcher sends the completion indication to the Response collector. The entries in the FreeList and finish list are updated to indicate completion upon arrival of this signal. The write request is sent directly to the MCU. The read request is split in multiple read requests of 16 byte each. A 4-bit entry is sent to a MCU Response block. The entry has one bit cleared per 16-byte request sent to the MCU, rest of the bits are kept set. The requests are then sent to the MCU with Refid. WrGnt to request is removed when MCU is not able to accept any more write requests. The RdGnt is removed during read processing as well as when the MCU Response Block is not able to allocate space for the Response data.

The MCU response block may maintain one or more of the following data structures.
The Response data storage 16 Entries of 16 Byte each are stored in Register File.
FreeList of Entries in data storage maintained in 16*4 bit array
Array indexed by Refid containing bit 4 mask, 4 indices in the Response data storage.

The Response storage block may receive requests from either the MCU or the response dispatcher. The one from MCU is taken at higher priority. These requests write data in the storage area. The requests from Response dispatcher are read requests. These are served in round robin fashion.

All the Response storage blocks are initially placed in the FreeList. They are allocated when MCU request block forwards the bit mask with request. The entries are deposited in this list when any of the Response dispatchers read out a block from the storage.

The Response Completion Array is accessed by Refid as an index. When an MCU request Block 124 sends a bit mask the associated entry is written. The indices of Response Data Storage are taken from the FreeList. Each time a response is received corresponding bit of the Bit mask is set. When the Bit Mask becomes 4′b1111 an indication is generated to the Request Composer block. The indication is held for one clock cycle. When a request with all bits set to 4′b1111 is received an immediate indication is sent to the Request Composer block and no further allocation is done.

There is one response dispatcher block per destination. A response composer, after detecting completion on both the channels send request to the appropriate dispatcher. The Refid, Address Bits, Size and tag information are passed as the request. The request dispatcher then makes requests to the MCU response blocks for reading the data. The requests are made in appropriate sequence based on values of size and the address bits. The information may be sent to an SDU destination under flow control. The Tag information is provided to the destination.

Each SDU Block 116 that has to communicate with other modules over the ring bus does so using a transaction encoder block. There is one transaction encoder block per TX link. When an SDU block intends to generate OCC on the RIB the SDU block makes a request to appropriate TEB. The OCC Request consists of the following fields:
OCC Header;
Size of Data from the block; and
Size of Data from the RLDRAM.

A request arbitration logic looks at the requesting ports in round robin manner. If a request is valid, the following steps are taken
1. If Size of RLDRAM is non-zero a tag is picked up from the FreeList and returned and an entry is made in the Posted Req Array. The Entry contains
   a. OCC Header information
   b. Size of Data from the block
   c. Size of Data from the RLDRAM
   d. Port of the Request (This is where the data will be picked up from)
2. If the Size of RLDRAM is zero then a request is made to the arbitration state machine. When the arbitration state machine grants the request OCC information is passed to it along with indication where to pick up payload from and the size of the payload. It is assumed that the Payload is available with the block.

A response arbitration state machine looks at the request arbitration port and the memory ports for valid request. If a request arbitration port makes a request, the OCC header information is sent to the TX FIFO. If the Size of the Payload is non-zero then the payload from the indicated block data port transferred to TX FIFO. This completes the transactions where OCC payload is zero or all the data to be sent is from on chip block. If the Request is detected from the Memory Port, the tag associated with the port is used for accessing the Posted Req Array. The OCC header information from the array is sent to the TX FIFO. The “Size of Data from block” field and “Port of Request” fields are used for accessing the preamble data to be sent from the SDU block. The remainder of the payload is extracted from the memory port that has provided the tag. This mechanism allows cases where SDU block needs to send 0 or more data words from the SDU block and rest of data from the RLDRAM.

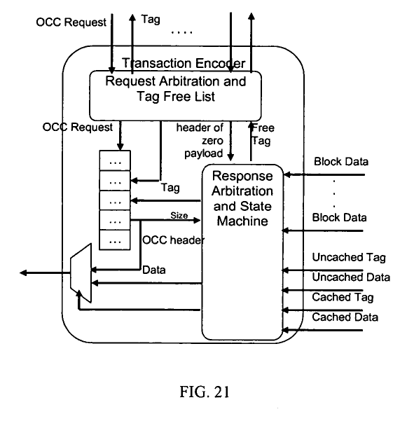

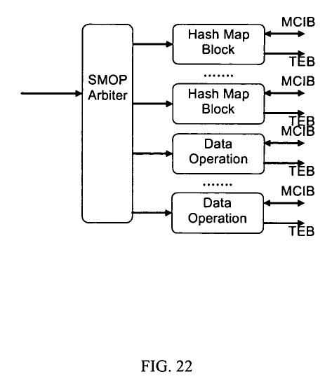

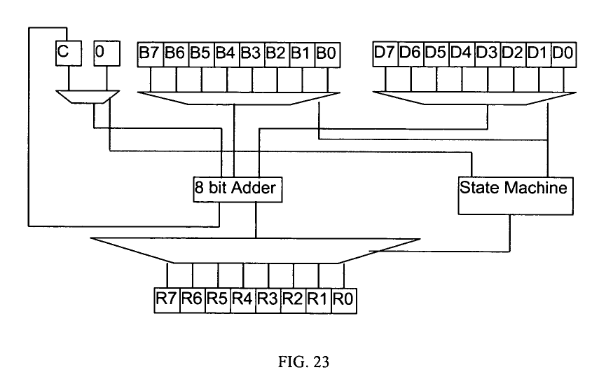

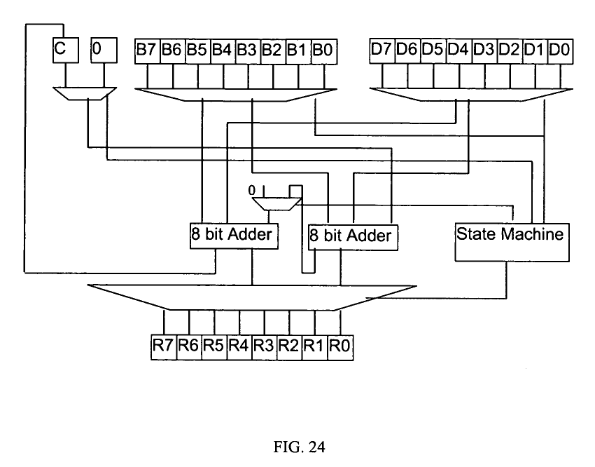

Referring now generally to the Figures and particularly to FIG. 21, FIG. 22, FIG. 23 and FIG. 24, a smart memory operations block 126 contains one top-level arbitration unit 128 and individual state machines 130 that handle smart memory operations. There are two types of state-machines, i.e. a Hash Map machine 132 and Data Operation Machine 134. Each type of state machine 130 is instantiated multiple times to provide parallel operations. The SMOP arbitration unit 128 keeps track of address operated by each state machine and blocks conflicting requests. In case of non-conflicting requests, it assigns them to first available state machine of required type.

Conflict Determination for Hash Map Machine 132

Requests for same hash map table are considered conflicting. The hash map state machine 132 stores the table index of operation under progress for each state machine. This index is provided along with request by the CPM.

Conflict Determination for the Data Operation Machine 134

Operation in each state machine 130 is indicated by a pair of registers viz. the address register indicating the base address of operation and the mask register. The mask register is generated from size parameter passed along with the request. The mask is set to exact size for naturally aligned accesses while as it spans two regions of given size in case of non-aligned accesses. Each incoming address is masked and compared with relevant bits of the base address. The matching cases are the conflicting requests, which are stalled.

The hash map operations are explained below as pseudo-code. The code assumes the following supporting blocks:
Load Hash Map Context: Loads BasePtr, NextFreePtr, EntrySize, KeySize from SRAM.
Compute Primary Address: Computes BasePtr+HashIndex*EntrySize
Get Entry: Gets the EntryValid, NextLinkValid, Key, NextPointer fields from the given address
Key Matched: Compares Key provided in input with key obtained from last read and return true or false.
Write Field: Overwrites specified fields in the last read entry.
Write Entry: Writes the modified entry to given address.
Save Hash Map Context: Stores NextFreePtr to SRAM.

HashMapGet

Load Hash Map Context;

```
Address = Compute Primary Address;
LOOP : Get Entry @ Address;
    If ( !EntryValid & !NextLinkValid) go to FAIL;
    If ( Entry Valid & Key Matched) go to FINISH;
    If ( !NextLinkValid) go to FAIL;
    Address = NextPointer;
    Go to LOOP;
FAIL : Return Error;
FINISH : Return Address;
HashMapPut
Laod Hash Map Context;
PrimaryFree = False;
Address = Compute Primary Address;
Get Entry @Address
If (!EntryValid) {
    PrimaryFree = True;
    If ( !NextLinkValid) go to ADD_ENTRY;
}
If ( EntryValid & Key Matched ) go to FINISH_1;
Address = NextPointer;
LOOP: GetEntry @ Address
    If ( Key Matched) go to FINISH_1
    If ( !NextLinkValid) go to ADD_ENTRY
    Address = NextPointer;
    go to LOOP;
ADD_ENTRY:
If (PrimaryFree) {
    Address = Get Primary Address;
    Get Entry @ Address;
    Set Field Key = Key;
    Set Field EntryValid = True;
    Write Entry @ Address;
    Go to FINISH_2;
}
else if ( NextFreePtr == INVALID ) go to FAIL;
else { /* Address = Last Valid entry and read-in */
    Set Field NextPointer = NextFreePtr;
    Set Field NextLinkValid = True;
    Write Entry @ Address
    Address = NextFreePtr;
    Get Entry @ Address
    NextFreePtr = NextPointer;
    Set Field Key = Key;
    Set Field EntryValid = True;
    Write Entry @ Address;
    Save Hash Map Context;
    Go to FINISH_2;
}
FAIL : Return Error;
FINISH_1 : Return Address , Entry Found;
FINISH_2 : Return Address, Entry Added;
Hash Map Remove
Laod Hash Map Context;
Address = Compute Primary Address;
Get Entry @Address
If (EntryValid & Key Matched) {
    Set Field EntryValid = False;
    Write Entry @ Address;
    Go to FINISH;
}
LOOP : If ( !NextLinkValid) go to FAIL;
    LastAddress = Address;
    Address = NextPointer;
    GetEntry @ Address
    If ( Key Matched) go to DELETE;
    Go to LOOP;
DELETE: TempLink = NextPointer
    TempNextLinkValid = NextLinkValid
    Set Field EntryValid = False;
    Set Filed NextPointer = NextFreePtr;
    Write Entry @ Address;
    NextFreePtr = Address;
    Load Entry @ LastAddress;
    Set Field NextLinkValid = TempNextLinkValid;
    Set Field NextPointer = TempNextPointer;
    Write Entry @ LastAddress;
    Save Hash Map Context;
    Go to FINISH;
FINISH : Return Success; /* Valid only for RemoveAck Command */
FAIL : Return Fail; /* Valid only for RemoveAck Command */
```

A data operation block performs three kinds of operation viz. Memory Read, Memory Write and Parallel Add.

Memory Read Operation

If the request size is greater than or equal to 16 bytes, request is made to TEB with OCC header. The tag returned by the TEB is sent to MCI along with the request and destination or response data is set to the TEB.

If request size is less than 16 Bytes the request is made to MCI and data is picked up from the MCI. The appropriate data (after lane shifting) is sent to TEB along with OCC.

Memory Write Operation

If the request size is greater than or equal to 16 bytes, request is broken into 16 Byte requests and sent to the MCI.

If request size is less than 16 Bytes, a read request is made to MCI and data is picked up from the MCI. The appropriate data is modified. A write request is made to the MCI with modified data.

Parallel Add Operation

A read request is made to MCI to retrieve 64 bytes of data from the specified address. Adder block is triggered to perform parallel add. The parallel add operation completes after “n” number of cycles. The results of addition are written back to same location.

The number of cycles taken by the parallel operation will be determined by the speed of the adders obtained from synthesis. The actual number will be 4, or 8 based on 16 bit or 8 bit adder.

The following table 8 shows the configuration registers for PGBQ implementation. This set is replicated for each of the queues.

TABLE 8
PGBQ Registers

| Name | Width | Description |
|---|---|---|
| CONFIG_SDU_PGBQ_BEGIN_ADDR_n¹ | 28 | Beginning address of PGBQ in DRAM |
| | | (64 byte aligned address forcing lower 6 |
| | | bits to be 0. The size of register can be |
| | | further reduced if we constrain that |
| | | PGBQ region should always be the first |
| | | region in the RLDRAMs) |
| CONFIG_SDU_PGBQ_STATUS_n¹ | 4 | Status bits Bit 0 = Pending Dequeue |
| | | request |
| | | Bit 1 = Read Region |
| | | Bit 2 = Write Region |
| | | Bit 3 = Overflow |
| CONFIG_SDU_PGBQ_MAX_ENTRIES_n¹ | 16 | Maximum number of entries in PGBQ |
| CONFIG_SDU_PGB_WRITE_INDEX_n¹ | 8 | Write Index pointer in the PGB Cache |
| CONFIG_SDU_PGBQ_READ_INDEX_n¹ | 16 | Current Read Pointer |
| CONFIG_SDU_PGBQ_WRITE_INDEX_n¹ | 16 | Current Write Pointer |

Note 1:
“_n” indicate the queue number (0-95)

Configuration registers for FreeList implementation are listed in Table 9.

TABLE 9
FreeList Registers

| Name | Width | Description |
|---|---|---|
| CONFIG_SDU_FREELIST_ALLOC_SEG | 4 | segment where allocation is |
| | | happening. |
| CONFIG_SDU_FREELIST_BASEADDR_n² | 28 | used for computing packet base |
| | | address from handle (Must be 128 |
| | | byte aligned any additional |
| | | restriction will help in reducing |
| | | size of adder) |
| CONFIG_SDU_FREELIST_NEXT_FREE_IND_n² | 16 | Points to next free bucket (0xFFFF |
| | | is invalid handle indicates it is |
| | | pointing to NULL) |
| CONFIG_SDU_FREELIST_CURR_PTR_n² | 8 | Pointer in the Cache indicating |
| | | free entry (0x00-0x80) 0x80 |
| | | indicate it is pointing outside the |
| | | cache and current cache is empty. |

Note 2:
“_n” indicate the segment number (0-15)

Configuration Registers for Hash Map implementation are noted in Table 10.

TABLE 10
Hash Map Registers

| | | De- |
|---|---|---|
| Name | Width | scription |
| CONFIG_SDU_HASH_BASEADDR_n³ | 28 | Base |
| | | Address |
| | | of the |
| | | Primary |
| | | area |
| CONFIG_SDU_HASH_NEXT_FREE_PTR_n³ | 32 | Points |
| | | to next |
| | | free |
| | | Entry |
| | | of the |
| | | overflow |
| | | area |
| CONFIG_SDU_HASH_ENTRY_SIZE_n³ | 8 | Size of |
| | | each |
| | | entry in |
| | | hash |
| | | table |
| CONFIG_SDU_HASH_KEY_SIZE_n³ | 8 | Size of |
| | | key |
| | | field |
| | | in hash |
| | | table |

Note 3:
“_n” indicate the Hash Map Table number (0-31)

From block level verification perspective, the following sequence may be preferred to develop and verify blocks:
Memory Controller interface
Packet Buffer FreeList
Transaction Encoder Block
PGBQ Block
Memory Operations Block
Packet DMA Block

The MCI and the Packet Buffer FreeList Block does not have direct command interface from RIU. There should be thin wrapper developed to interface these blocks to the standard block level verification environment. Other blocks may optionally interface to RIU an can be connected to a module level verification environment with null RIU (RIU that does not implement queues but connect one RIB RX port to these block directly with stall implementation) These blocks interface to the Memory through pre-verified MCI.

A block can be verified using behavior model of the MCU. The cases that can be verified are
Write to a location
Two Writes back to back
Write to a location followed by read
Write to multiple location followed by read in same order
Write to a location with multiple reads from the same location
Multiple reads to different locations
Write followed by read followed by write followed by read to same location
Reads of different sizes
More than 16 pending reads

A packet buffer FreeList block does not have direct connection from the RIU. It provides services to the PGBQ block and the Packet DMA block. This block shall be verified first. Conditions to check for
One Alloc Followed by one Free followed by another alloc followed by another Free
Alloc 30 followed by free 30 followed by alloc 30 followed by free 30
Alloc 32 followed by free 32 followed by alloc 32 followed by free 32
Alloc 33 followed by free 33 followed by alloc 33 followed by free 33
Alloc 33 followed by free 3 followed by alloc 40 followed by free 70
Alloc which requires crossing segment boundaries
Free for segments other than Current allocation segment
Free mixed in current and other segments
Alloc spanning across fully occupied segments

A transaction encoder block shall be verified for the following conditions
OCC header provided with no data requirements
OCC header provided with data from the SDU block
OCC header provided with data from memory only
OCC header provided with data from the block and the memory
All above condition with data throttling
Interleaving of the above requests during data waiting period

The PGBQ block should be exercised by providing commands directly to the interface. It should be hooked to previously verified Packet Buffer FreeList block, TEB, and the MCI. The following test cases indicate basic test cases.
Enqueue 1 entry to single queue followed by Dequeue from the same queue;
Enqueue 4 entries to single queue followed by Dequeue from the same queue;
Enqueue 8 entries to single queue (This will require multiple Enqueue commands) followed by Dequeue from the same queue;
Enqueue 10 entries to single queue (This will require multiple Enqueue commands) followed by two Dequeue commands from the same queue;
Dequeue from an empty queue followed by Enqueue to same queue;
Dequeue from an empty queue followed by Enqueue to different queue followed by Enqueue to pending queue;
Enqueue to multiple queues followed by Dequeue from those queues;
Dequeue to empty queue followed by Enqueue to multiple queues including pending queue as first queue;
Dequeue to empty queue followed by Enqueue to multiple queues including pending queue as intermediate queue; and
Dequeue to empty queue followed by Enqueue to multiple queues including pending queue as last queue.

The memory operations block can verified with the following test cases
Memory Write of 16 Bytes
Memory Read of 16 Bytes
Memory writes of multiples of 16 Bytes (Naturally aligned)
Memory Reads of multiples of 16 Bytes (naturally aligned)
Non-naturally aligned Reads Writes of multiples of 16 bytes
Reads and Writes of less than 16 bytes
Write—Read—Write—Read of (1, 2, 4, 8, 16, 32, 48 Bytes)
Same as above except for non-conflicting locations
Overlapping regions in above requests (2 bytes of same 32 byte previous req)
Hash Map Put with empty hash map
Hash Map Get with empty hash map
Hash Map Put—Get on Primary
Hash Map Put—Put (conflict hash)—Get Primary
Hash Map Put—Put (conflict hash)—get overflow
Hash Map Put—Put (conflict hash)—remove primary—put (conflict hash)
Hash Map Put—Put (conflict hash)—remove overflow—put (conflict hash)
Hash Map Put—Put (conflict hash)—Put (conflict hash)—remove second—put (conflict hash)

The possible test cases are for a packet DMA block may include the following:
Move A to E with the following variants of A
   First Header has full pay load no link buffers
   First Header has full pay load with one/more NBL valid
   First Header has full pay load with all NBL valid and NHL valid
   First Header has full pay load with No NBL valid and NHL valid with some of above conditions
   First header has non-aligned SOD/EOD and partial pay load with above conditions
The payload size can be changed to check if E1 and E2 are created properly
Move E to A can be checked for
   E1 formatted packet
   E2 formatted packet
   Generation with Header and at least one NBL required
   Generation with only header is required and SOD EOD need to be generated
   Generation with more than one header is required.
A to Linear and Linear to A can be tested by generating sample data as above.
Parallel sate machines to be tested with issuing commands that trigger them and the response data is interleaved.

The following memories may be used in various alternate preferred embodiments of the SDU block of the second version 36:

| Memory | Function | Area |
|---|---|---|
| 19968 Bytes SRAM | PGBQB | |
| 640 Bytes * Number of Inst (??) | A to E Conversion | |
| 128 Bytes Register File | E to A Conversion | |
| 2048 Bytes | Packet Buffer FreeList | |
| 256 Bytes Register Files per | MCI MCU Response | |
| instance (4 inst) | Block | |
| 128 Bytes Register File per | MCI Response collector | |
| instance(2 inst) | | |
| 128 * 64 Bit per instance (4 inst) | TEB | |

Many features have been listed with particular configurations, options, and embodiments. Any one or more of the features described may be added to or combined with any of the other embodiments or other standard devices to create alternate combinations and embodiments. The features of one of the functions may also be used with other functions. Although the examples given include many specificities, they are intended as illustrative of only one possible embodiment of the invention. Other embodiments and modifications will, no doubt, occur to those skilled in the art. Thus, the examples given should only be interpreted as illustrations of some of the preferred embodiments of the invention, and the full scope of the invention should be determined by the appended claims and their legal equivalents.

We claim:

1. In a network processor system, a method for dynamically storing and accessing packets to and from a random access memory, the network processor system having a CPU communicatively coupled with the random access memory, the method comprising:
(a) forming a software model of the memory locations of the random access memory, the software model assigning each of a plurality of packet addresses to a separate block of memory addresses of the random access memory;
(b) receiving a first packet by the network processor system; and
(c) storing the first packet in a block of memory addresses associated with a first packet address of the software model.

2. The method of claim 1, wherein the method further comprises reading the first packet from the random access memory by referencing the first packet address.

3. The method of claim 1, wherein the method further comprises forming a packet group buffer in the software model, the packet group buffer for storing the packet addresses individual packets stored in the random access memory.

4. The method of claim 3, wherein the method further comprises determining the length of each packet associated with each packet address stored in the packet group buffer, and storing the length in the packet group buffer, in association with the corresponding packet address.

5. The method of claim 4, wherein the packet group buffer is stored in the random access memory.

6. The method of claim 3, wherein the packet group buffer is stored in the random access memory.

7. The method of claim 6, wherein the software model further comprises a plurality of packet group buffers, and a packet group buffer queue, the packet buffer group queue containing a designation of a plurality of packet group buffer, wherein each designated packet group buffer is selected for reading at least one packet from the packet addresses listed in the corresponding packet group buffer.

8. The method of claim 3, wherein the network processor system further comprises a memory, and the packet group buffer is stored in the memory of the network processor system.

9. A system for dynamically allocating memory to a random access memory for access by a network controller processor, the system comprising:
(a) a memory manager device, the memory manager device communicatively coupled with the network control processor and the random access memory, and storing a software model of the random access memory and a device driver;
(b) the software model allocating memory blocks of the random access memory as uniquely addressed packet addresses; and
(c) the device driver configured to:
(i) determine the unused memory blocks as designated by the packet addresses; and
(ii) inform the network control processor of the packet addresses of the unused memory blocks.

10. The system of claim 9, wherein the system further comprises a packet group buffer of the software model, the packet group buffer storing the packet addresses of individual packets stored in the random access memory.

11. The system of claim 10, wherein the packet group buffer is stored in the random access memory.

12. The system of claim 10, wherein the packet group buffer further comprises a stored length of each packet associated with each packet address stored in the packet group buffer, and the length of each packet stored in the packet group buffer in association with the corresponding packet address.

13. The method of system 12, wherein the packet group buffer is stored in the random access memory.

14. In a network processor system having a CPU and a system memory, a method to manage packet memory storage and access in and from a packet memory, the method comprising:
a CPU requesting a packet memory block designation from a FreeList, the FreeList stored in the system memory, and the FreeList comprising a plurality of packet memory block designations of corresponding packet memory blocks of the packet memory, each packet memory block free to accept storage of a memory packet.
the CPU receiving a selected packet memory block designation from the FreeList; and
writing the packet from the network processor to the packet memory block of the packet memory corresponding to the selected packet memory block designation.

15. The method of claim 14, the method further comprising storing a data mirror of the FreeList as stored in the system memory in a FreeList buffer of the packet memory, whereby the packet memory and the system memory maintain substantively identical FreeLists substantively contemporaneously.

16. The method of claim 14, the method further comprising forming a packet buffer group data structure in the system memory, the packet buffer group data structure storing each of a plurality of packet memory block designations with a corresponding packet length parameter.

17. The method of claim 16, the method further comprising storing a data mirror of the packet buffer group data structure as stored in the system memory in a second packet buffer group memory of the packet memory, whereby the packet buffer group data structure and the second packet buffer group memory maintain substantively identical packet substantively contemporaneously.

18. The method of claim 14, the method further comprising forming a second packet buffer group memory of the packet memory, second packet buffer group memory storing each of a plurality of packet memory block designations with a corresponding packet length parameter.

19. The method of claim 16, the method comprising a packet group buffer queue data structure in the system memory, the packet group buffer queue data structure for containing addresses of packet memory block designations, and storing at least one packet memory block designation of a packet scheduled for egress from the packet memory.

20. The method of claim 16, the method comprising a packet group buffer queue data structure in the packet memory, the packet group buffer queue data structure for containing addresses of packet memory block designations, and storing at least one packet memory block designation of a packet scheduled for egress from the packet memory.
